(19) United States
(12) Patent Application Publication
(10) Pub. No.: US 2022/0408021 A1
(43) Pub. Date: Dec. 22, 2022

(54) INFORMATION PROCESSING DEVICE AND METHOD, IMAGING APPARATUS AND METHOD, PROGRAM, AND INTERCHANGEABLE LENS

(71) Applicant: Sony Group Corporation, Tokyo (JP)

(72) Inventors: Kengo Hayasaka, Kanagawa (JP); Katsuhisa Ito, Tokyo (JP)

(21) Appl. No.: 17/777,451

(22) PCT Filed: Dec. 7, 2020
(86) PCT No.: PCT/JP2020/045368

§ 371 Date: May 17, 2022

(30) Foreign Application Priority Data
Dec. 20, 2019 (JP) 2019-230032

(51) Int. Cl. H04N 5/232; H04N 5/262; G02B 27/10

(52) U.S. Cl. CPC H04N 5/23245; H04N 5/2628; G02B 27/1013

(57) ABSTRACT

The present disclosure relates to an information processing device and method, an imaging apparatus and method, a program, and an interchangeable lens that enable acquisition of viewpoint images in accordance with an imaging mode.

For a captured image generated by an image sensor that has different positions irradiated with the respective irradiation light beams having passed through a plurality of monocular optical systems that have optical paths independent of one another, viewpoint image regions that are the regions of the respective viewpoint images corresponding to the respective monocular optical systems are set in accordance with the imaging mode of the captured image. The present disclosure can be applied to an information processing device, an electronic apparatus, an interchangeable lens or a camera system that includes a plurality of monocular optical systems, an information processing method, an imaging method, a program, or the like, for example.

### TECHNICAL FIELD

The present disclosure relates to information processing devices and methods, imaging apparatuses and methods, programs, and interchangeable lenses, and more particularly, to an information processing device and method, an imaging apparatus and method, a program, and an interchangeable lens that are designed to be capable of obtaining viewpoint images corresponding to imaging modes.

### BACKGROUND ART

There have been methods suggested for generating a captured image obtained through a wide-angle lens and a captured image obtained through a telephoto lens at different positions on the same imaging surface (see Patent Document 1, for example).

### CITATION LIST

### Patent Document

### Patent Document 1: Japanese Patent Application Laid-Open No. 2015-148765

### SUMMARY OF THE INVENTION

### Problems to be Solved by the Invention

However, in the case of the method disclosed in Patent Document 1, setting the sizes and the shapes of captured images in accordance with imaging modes has not been considered.

The present disclosure is made in view of such circumstances, and is to enable formation of viewpoint images in accordance with imaging modes.

### Solutions to Problems

An information processing device according to one aspect of the present technology is an information processing device that includes a setting unit that sets viewpoint image regions in accordance with the imaging mode of a captured image, the captured image being generated by an image sensor that has different positions irradiated with irradiation light beams having passed through a plurality of monocular optical systems that have optical paths independent of one another, the viewpoint image regions being the regions of the viewpoint images corresponding to the respective monocular optical systems.

An information processing method according to one aspect of the present technology is an information processing method that includes: setting viewpoint image regions in accordance with the imaging mode of a captured image, the captured image being generated by an image sensor that has different positions irradiated with irradiation light beams having passed through a plurality of monocular optical systems that have optical paths independent of one another, the viewpoint image regions being the regions of the viewpoint images corresponding to the respective monocular optical systems.

A program according to one aspect of the present technology is a program for causing a computer to function as a setting unit that sets viewpoint image regions in accordance with the imaging mode of a captured image, the captured image being generated by an image sensor that has different positions irradiated with irradiation light beams having passed through a plurality of monocular optical systems that have optical paths independent of one another, the viewpoint image regions being the regions of the viewpoint images corresponding to the respective monocular optical systems.

An imaging apparatus according to another aspect of the present technology is an imaging apparatus that includes: an imaging unit that generates a captured image by photoelectrically converting, in a predetermined imaging mode, irradiation light beams having passed through a plurality of monocular optical systems that have optical paths independent of one another; and a setting unit that sets, in accordance with the imaging mode, viewpoint image regions for the captured image generated by the imaging unit, the viewpoint image regions being the regions of the viewpoint images corresponding to the respective monocular optical systems.

An imaging method according to another aspect of the present technology is an imaging method that includes: generating a captured image by photoelectrically converting, in a predetermined imaging mode, irradiation light beams having passed through a plurality of monocular optical systems that have optical paths independent of one another; and setting, in accordance with the imaging mode, viewpoint image regions for the generated captured image, the viewpoint image regions being the regions of the viewpoint images corresponding to the respective monocular optical systems.

A program according to another aspect of the present technology is a program for causing a computer to function as: an imaging unit that generates a captured image by photoelectrically converting, in a predetermined imaging mode, irradiation light beams having passed through a plurality of monocular optical systems that have optical paths independent of one another; and a setting unit that sets, in accordance with the imaging mode, viewpoint image regions for the captured image generated by the imaging unit, the viewpoint image regions being the regions of the viewpoint images corresponding to the respective monocular optical systems.

An interchangeable lens according to yet another aspect of the present technology is an interchangeable lens that includes: a plurality of monocular optical systems having optical paths independent of one another; and a storage unit that stores viewpoint region information, the viewpoint region information being information related to each imaging mode and indicating viewpoint image regions, the viewpoint image regions being the regions of the viewpoint images corresponding to the respective monocular optical systems.

In the information processing device and method, and the program according to one aspect of the present technology, viewpoint image regions are set in accordance with the imaging mode of a captured image, the captured image being generated by an image sensor that has different positions irradiated with irradiation light beams having passed through a plurality of monocular optical systems that have optical paths independent of one another, the viewpoint image regions being the regions of the viewpoint images corresponding to the respective monocular optical systems.

In the imaging apparatus and method, and the program according to another aspect of the present technology, a captured image is generated by photoelectrically converting, in a predetermined imaging mode, irradiation light beams having passed through a plurality of monocular optical systems that have optical paths independent of one another. For the generated captured image, viewpoint image regions are set in accordance with the imaging mode, the viewpoint image regions being the regions of the viewpoint images corresponding to the respective monocular optical systems.

In the interchangeable lens according to yet another aspect of the present technology, a plurality of monocular optical systems having optical paths independent of one another, and a storage unit that stores viewpoint region information are provided, the viewpoint region information being information related to each imaging mode and indicating viewpoint image regions, the viewpoint image regions being the regions of the viewpoint images corresponding to the respective monocular optical systems.

### BRIEF DESCRIPTION OF DRAWINGS

FIG. 1 is a perspective view showing an example configuration of an embodiment of a camera to which the present technology is applied.

FIG. 2 is a block diagram showing an example electrical configuration of the camera.

FIG. 3 is a diagram showing an example of a three-plate image sensor.

FIG. 4 is a diagram showing an example of a whole image.

FIG. 5 is a diagram showing an example of viewpoint images.

FIG. 6 is a diagram showing an example of a composite image.

FIG. 7 is a diagram for explaining an example of irradiation light beams with which an effective pixel region is irradiated.

FIG. 8 is a diagram for explaining an example of effective pixel regions corresponding to imaging modes.

FIG. 9 is a diagram showing an example of setting of viewpoint image regions in accordance with imaging modes.

FIG. 10 is a flowchart for explaining an example flow in an imaging process.

FIG. 11 is a diagram showing an example of setting of viewpoint image regions in accordance with imaging modes.

FIG. 12 is a flowchart for explaining an example flow in an imaging process.

FIG. 13 is a perspective view showing an example configuration of an embodiment of a camera system to which the present technology is applied.

FIG. 14 is a block diagram showing an example electrical configuration of the camera system.

FIG. 15 is a block diagram showing a principal example configuration of a computer.

### MODES FOR CARRYING OUT THE INVENTION

The following is a description of modes for carrying out the present disclosure (these modes will be hereinafter referred to as embodiments). Note that explanation will be made in the following order.

1. First Embodiment (Camera)

2. Second Embodiment (Camera System)

3. Notes

### 1. First Embodiment

<Exterior of a Camera>

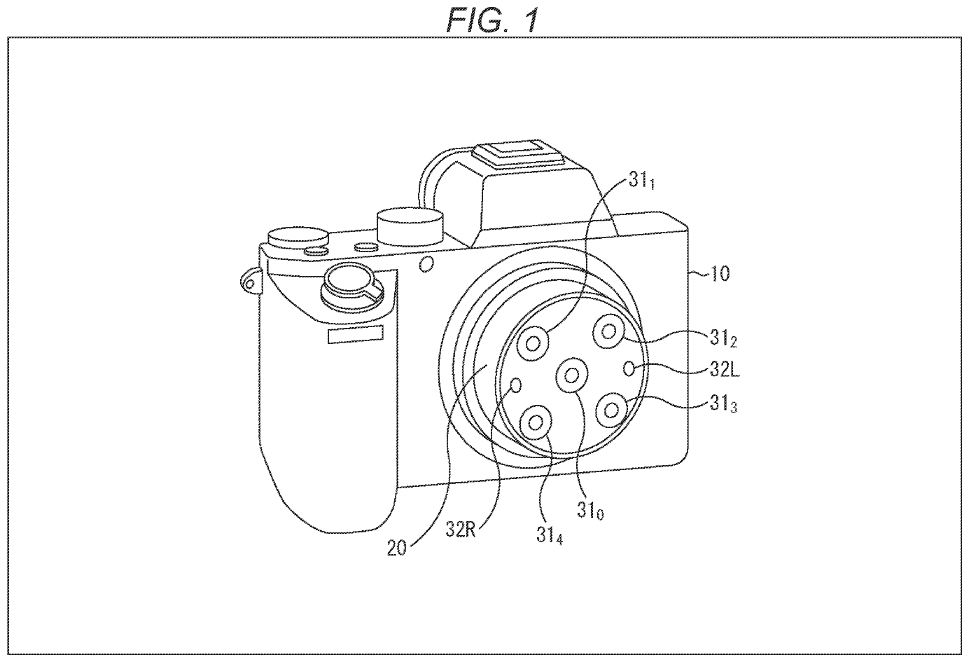

FIG. 1 is a perspective view of an example configuration of an embodiment of a camera to which the present technology is applied.

A camera 10 includes an image sensor, receives light beams collected by lenses, and performs photoelectric conversion, to capture an image of an object. Hereinafter, an image obtained through such imaging will be also referred to as a captured image.

The camera 10 has a lens barrel 20 on the front side (the side at which light enters) of the image sensor, and the lens barrel 20 includes five monocular optical systems 31₀, 31₁, 31₂, 31₃, and 31₄ as a plurality of monocular optical systems. Hereinafter, the monocular optical systems 31₀ to 31₄ will be referred to as monocular optical systems 31 (or monocular optical systems 31ᵢ) in a case where there is no need to distinguish the monocular optical systems 31 from one another.

The plurality of monocular optical systems 31 is designed so that the optical paths of light passing through the respective systems are independent of one another. That is, light having passed through each of the monocular optical systems 31 of the lens barrel 20 is emitted onto a different position on the light receiving surface (for example, the effective pixel region) of the image sensor, without entering the other monocular optical systems 31. At least the optical axes of the respective monocular optical systems 31 are located at different positions on the light receiving surface of the image sensor, and at least part of the light passing through the respective monocular optical systems 31 is emitted onto different positions on the light receiving surface of the image sensor.

Accordingly, in the captured image generated by the image sensor (the entire image output by the image sensor), the images of the object formed through the respective monocular optical systems 31 are formed at different positions. In other words, from the captured image, captured images (also referred to as viewpoint images) with the respective monocular optical systems 31 being the viewpoints are obtained. That is, the camera 10 can obtain a plurality of viewpoint images by imaging an object. The plurality of viewpoint images can be used for processes such as generation of depth information and refocusing using the depth information, for example.

Note that, in the description below, an example in which the camera 10 includes the five monocular optical systems 31 will be described, but the number of the monocular optical systems 31 may be any number that is two or greater.

The five monocular optical systems 31 are arranged so that, with the monocular optical system 31₀ being the center (gravity center), the other four monocular optical systems 31₁ to 31₄ form the vertices of a rectangle in a two-dimensional plane that is orthogonal to the optical axis of the lens barrel 20 (or is parallel to the light receiving surface (imaging surface) of the image sensor). The arrangement shown in FIG. 1 is of course an example, and the respective monocular optical systems 31 can be in any positional relationship, as long as the optical paths are independent of one another.

Further, as for the camera 10, the surface on the side from which light from the object enters is the front surface.

### Example Electrical Configuration of the Camera

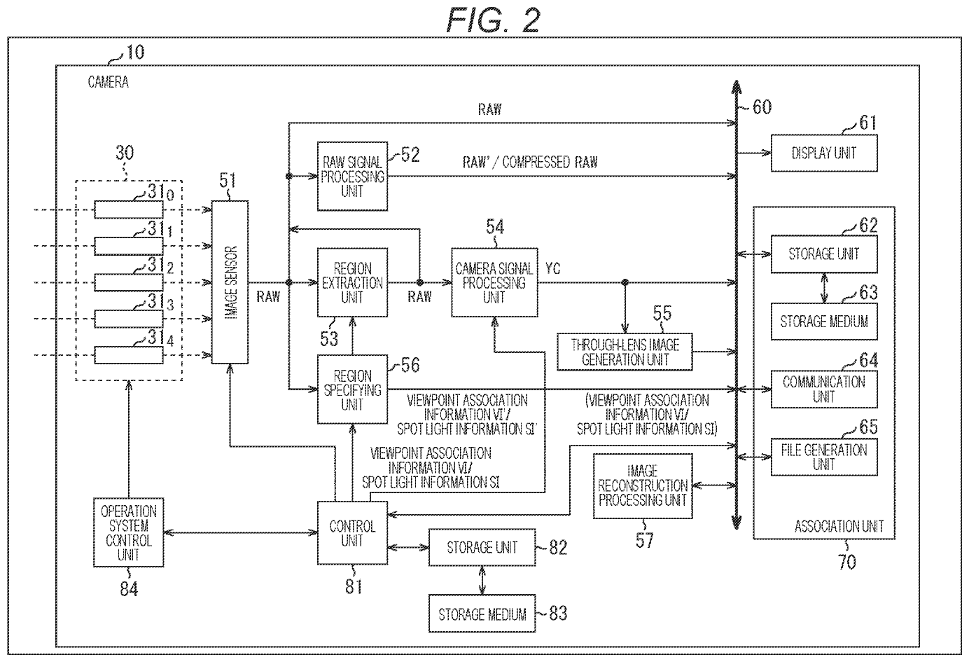

FIG. 2 is a block diagram showing an example electrical configuration of the camera 10 shown in FIG. 1. The camera 10 includes a multiple optical system 30, an image sensor 51, a RAW signal processing unit 52, a region extraction unit 53, a camera signal processing unit 54, a through-lens image generation unit 55, a region specifying unit 56, an image reconstruction processing unit 57, a bus 60, a display unit 61, a storage unit 62, a communication unit 64, a file generation unit 65, a control unit 81, a storage unit 82, and an optical system control unit 84.

<Multiple Optical System>

The multiple optical system 30 includes the above-described monocular optical systems 31 (the monocular optical systems 31a to 31₄, for example). Each of the monocular optical systems 31 of the multiple optical system 30 condenses light beams from the object onto the image sensor 51 of the camera 10. The specifications of the respective monocular optical systems 31 are the same.

<Image Sensor>

The image sensor 51 is a complementary metal oxide semiconductor (CMOS) image sensor, for example, and captures of the object, to generate a captured image. The light receiving surface of the image sensor 51 is irradiated with light beams condensed by the respective monocular optical systems 31₀ to 31₄. In a captured image, the image corresponding to the region to which the irradiation light beam with which the image sensor 51 is irradiated via one monocular optical system 31 is input is also referred to as a monocular image. That is, the image sensor 51 receives these light beams (irradiation light beams) and performs photoelectric conversion, to generate a captured image including monocular images viewed from the respective monocular optical systems 31. Note that a monocular image has portions that are not effective as an image in its periphery. Also, a captured image including all monocular images (which is an entire captured image generated by the image sensor 51, or an image formed by deleting, from the captured image, some or all of the regions outside all the monocular images included in the captured image) is also referred to as a whole image.

Note that the image sensor 51 may be a unicolor (so-called monochromatic) image sensor, or may be a color image sensor in which color filters in the Bayer array are arranged in a pixel group, for example. That is, a captured image output by the image sensor 51 may be a monochrome image or a multicolor image. In the description below, the image sensor 51 is a color image sensor, and generates and outputs a captured image in the RAW format.

Note that, in this embodiment, the RAW format means an image in a state where the positional relationship in the layout of the color filters of the image sensor 51 is maintained, and may include an image obtained by performing signal processing such as an image size conversion process, a noise reduction process, or a defect correction process for the image sensor 51, and compression encoding on an image output from the image sensor 51. Furthermore, captured images in the RAW format do not include any monochromatic image.

The image sensor 51 can output a captured image (whole image) in the RAW format generated by photoelectrically converting irradiation light beams. For example, the image sensor 51 can supply the captured image (whole image) in the RAW format to at least one of the following components: the bus 60, the RAW signal processing unit 52, the region extraction unit 53, and the region specifying unit 56.

For example, the image sensor 51 can supply the captured image (whole image) in the RAW format to the storage unit 62 via the bus 60, and store the captured image into a storage medium 63. Also, the image sensor 51 can supply the captured image (whole image) in the RAW format to the communication unit 64 via the bus 60, and cause the communication unit 64 to transmit the captured image to the outside of the camera 10. Further, the image sensor 51 can supply the captured image (whole image) in the RAW format to the file generation unit 65 via the bus 60, and cause the file generation unit 65 to turn the captured image into a file. Furthermore, the image sensor 51 can supply the captured image (whole image) in the RAW format to the image reconstruction processing unit 57 via the bus 60, and cause the image reconstruction processing unit 57 to perform an image reconstruction process.

Note that the image sensor 51 may be a single-plate image sensor, or may be a set of image sensors (also referred to as a multi-plate image sensor) including a plurality of image sensors, such as a three-plate image sensor, for example.

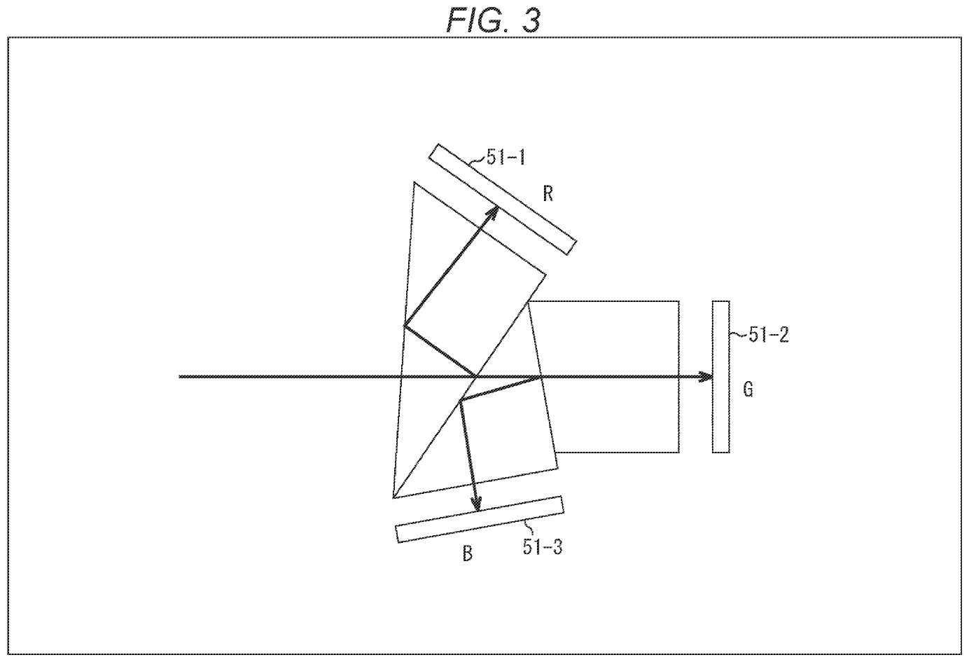

For example, a three-plate image sensor may be an image sensor including three image sensors (image sensors 51-1 to 51-3) for the respective colors of RGB (Red, Green, and Blue), as shown in FIG. 3. In this case, light beams from the object are separated for the respective wavelength ranges through an optical system (an optical path separation unit) such as a prism, and then enters each image sensor. The image sensors 51-1 to 51-3 each photoelectrically convert the incident light. That is, the image sensors 51-1 to 51-3 photoelectrically convert light in different wavelength ranges at substantially the same timing. Accordingly, in the case of a multi-plate image sensor, the respective image sensors obtain images captured at substantially the same angle of view at substantially the same time (that is, images having substantially the same pattern but in different wavelength ranges). Thus, the positions and the sizes of the viewpoint image regions (described later) in the captured images obtained by the respective image sensors are substantially the same. In this case, a combination of an R image, a G image, and a B image can be regarded as a captured image in the RAW format.

Note that, in the case of a multi-plate image sensor, the respective image sensors are not necessarily those for the respective colors of RGB, but all of the image sensors may be monochromatic image sensors, or may include color filters in the Bayer array or the like. Note that, in a case where all the color filters are color filters in the Bayer array or the like, if all the arrays are the same and the positional relationships among the pixels are uniform, noise reduction can be performed, for example. If the positional relationships among the respective image sensors for RGB are made to vary, it is also possible to enhance image quality, taking advantage of the effect of so-called spatial pixel shifting, for example.

In the case of such a multi-plate imaging apparatus, a plurality of monocular images and a plurality of viewpoint images are also included in a captured image output from each image sensor, or one image sensor.

<RAW Signal Processing Unit>

The RAW signal processing unit 52 performs processes related to signal processing on an image in the RAW format. For example, the RAW signal processing unit 52 can acquire a captured image (whole image) in the RAW format supplied from the image sensor 51. Also, the RAW signal processing unit 52 can perform predetermined signal processing on the acquired captured image. The specifics of the signal preprocessing may be any appropriate processing. For example, the signal processing may be defect correction, noise reduction, compression (encoding), or the like, or may be some other signal processing. The RAW signal processing unit 52 can of course also perform a plurality of kinds of signal processing on the captured image. Note that the various kinds of signal processing on an image in the RAW format are performed only on an image that has been subjected to the signal processing and maintains the positional relationship in the layout of the color filters of the image sensor 51 as described above (or an image maintaining the R image, the G image, and the B image, in the case of a multi-plate imaging apparatus).

The PAW signal processing unit 52 can supply the captured image (RAW′) in the RAW format subjected to the signal processing or the compressed (encoded) captured image (compressed RAW) to the storage unit 62 via the bus 60, and store the captured image into the storage medium 63. Also, the PAW signal processing unit 52 can supply the captured image (RAW′) in the RAW format subjected to the signal processing or the compressed (encoded) captured image (compressed RAW) to the communication unit 64 via the bus 60, and causes the communication unit 64 to transmit the captured image. Further, the RAW signal processing unit 52 can supply the captured image (RAW′) in the RAW format subjected to the signal processing or the compressed (encoded) captured image (compressed RAW) to the file generation unit 65 via the bus 60, and causes the file generation unit 65 to turn the captured image into a file. Also, the RAW signal processing unit 52 can supply the captured image (RAW′) in the RAW format subjected to the signal processing or the compressed (encoded) captured image (compressed RAW) to the image reconstruction processing unit 57 via the bus 60, and causes the image reconstruction processing unit 57 to perform an image reconstruction process. Note that, in a case where there is no need to distinguish the RAW, the RAW′, and the compressed RAW (all of which are shown in FIG. 2) from one another, they are referred to as RAW images.

<Region Extraction Unit>

The region extraction unit 53 performs processes related to extraction of a region (clipping of a partial image) from a captured image in the RAW format. For example, the region extraction unit 53 can acquire a captured image (whole image) in the RAW format supplied from the image sensor 51. Also, the region extraction unit 53 can acquire information (also referred to as extraction region information) indicating the region to be extracted from the captured image, the information being supplied from the region specifying unit 56. The region extraction unit 53 can then extract a partial region (cut out a partial image) from the captured image, on the basis of the extraction region information.

For example, the region extraction unit 53 can cut out images from the captured image (whole image), the images being viewed from the respective monocular optical systems 31. That is, the region extraction unit 53 can cut out effective portions, as the images viewed from the respective monocular optical systems 31, from the regions of the respective monocular images included in the captured image. The images of the cutout effective portions (part of the monocular images) are also referred to as viewpoint images. Further, the cutout regions (the regions corresponding to the viewpoint images) in the captured image are referred to as viewpoint image regions. For example, the region extraction unit 53 can acquire, as the extraction region information, viewpoint association information that is supplied from the region specifying unit 56 and is used for specifying the viewpoint image regions, and extract each viewpoint image region indicated in the viewpoint association information from the captured image (or cut out each viewpoint image). The region extraction unit 53 can then supply the cutout respective viewpoint images (in the RAW format) to the camera signal processing unit 54.

The region extraction unit 53 can also combine the respective viewpoint images cut out from the captured image (whole image), to generate a composite image, for example. The composite image is obtained by combining the respective viewpoint images into one set of data or one image. For example, the region extraction unit 53 can generate one image (a composite image) in which the respective viewpoint images are arranged in a planar manner. The region extraction unit 53 can supply the generated composite image (in the RAW format) to the camera signal processing unit 54.

The region extraction unit 53 can also supply the whole image to the camera signal processing unit 54, for example. The region extraction unit 53 can extract a partial region including all the monocular images from the acquired captured image (or cut out a partial image including all the monocular images), for example, and supply the camera signal processing unit 54 with the cutout partial image (which is an image obtained by deleting part or all of the regions outside all of the monocular images included in the captured image) as the whole image in the RAW format. The location (range) of the region to be extracted in this case may be determined beforehand by the region extraction unit 53, or may be designated by the viewpoint association information supplied from the region specifying unit 56.

The region extraction unit 53 can also supply the acquired captured image (which is not a partial image including all the cutout monocular images, but the entire captured image) as the whole image in the RAW format to the camera signal processing unit 54.

Note that the region extraction unit 53 can supply the partial image (the whole image, viewpoint images, or a composite image) in the RAW format cut out from the captured image as described above to the storage unit 62, the communication unit 64, the file generation unit 65, the image reconstruction processing unit 57, or the like via the bus 60, as in the case of the image sensor 51.

The region extraction unit 53 can also supply the partial image (the whole image, viewpoint images, or a composite image) in the RAW format to the RAW signal processing unit 52, and cause the RAW signal processing unit 52 to perform predetermined signal processing or compression (encoding). In this case, the RAW signal processing unit 52 can also supply the captured image (RAW′) in the RAW format subjected to the signal processing or the compressed (encoded) captured image (compressed RAW) to the storage unit 62, the communication unit 64, the file generation unit 65, the image reconstruction processing unit 57, or the like via the bus 60.

That is, at least one among the captured image (or the whole image), a viewpoint image, and a composite image may be a RAW image.

<Camera Signal Processing Unit>

The camera signal processing unit 54 performs processes related to camera signal processing on an image. For example, the camera signal processing unit 54 can acquire an image (a whole image, a viewpoint image, or a composite image) supplied from the region extraction unit 53. The camera signal processing unit 54 can also perform camera signal processing (a camera process) on the acquired image. For example, the camera signal processing unit 54 can perform, on the current image, a color separation process (a demosaicing process in a case where mosaic color filters in the Bayer array or the like are used) for separating the respective colors of RGB to generate an R image, a G image, and a B image each having the same number of pixels as the current image, a YC conversion process for converting the color space of the image subjected to the color separation from RGB to YC (luminance/color difference), and the like. The camera signal processing unit 54 can also perform processing, such as defect correction, noise reduction, automatic white balance (AWB), or gamma correction, on the current image. Further, the camera signal processing unit 54 can also compress (encode) the current image. The camera signal processing unit 54 can of course perform a plurality of camera signal processing operations on the current image, or can perform camera signal processing other than the above-described examples.

Note that the description below is based on the assumption that the camera signal processing unit 54 acquires an image in the RAW format, performs a color separation process or YC conversion on the image, and outputs an image (YC) in the YC format. This image may be a whole image, each viewpoint image, or a composite image. Further, the image (YC) in the YC format may be encoded, or may not be encoded. That is, the data that is output from the camera signal processing unit 54 may be either encoded data or unencoded image data.

That is, at least one image among a captured image (or a whole image), a viewpoint image, and a composite image may be an image in the YC format (also referred to as a YC image).

Further, an image that is output by the camera signal processing unit 54 is not subjected to a complete development process, and may not be subjected as an image (YC) in the YC format to some or all of processes related to irreversible image quality adjustment (color adjustment) such as gamma correction or a color matrix. In this case, the image (YC) in the YC format can be returned to an image in the RAW format substantially without any degradation in the stage that follows, during reproduction, or the like.

For example, the camera signal processing unit 54 can supply the image (YC) in the YC format subjected to the camera signal processing, to the display unit 61 via the bus 60, and causes the display unit 61 to display the image. Also, the camera signal processing unit 54 can supply the image (YC) in the YC format subjected to the camera signal processing, to the storage unit 62 via the bus 60, and causes the storage unit 62 to store the image into the storage medium 63. Further, the camera signal processing unit 54 can supply the image (YC) in the YC format subjected to the camera signal processing, to the communication unit 64 via the bus 60, and causes the communication unit 64 to transmit the image to the outside. Also, the camera signal processing unit 54 can supply the image (YC) in the YC format subjected to the camera signal processing, to the file generation unit 65 via the bus 60, and causes the file generation unit 65 to turn the image into a file. Further, the camera signal processing unit 54 can supply the image (YC) in the YC format subjected to the camera signal processing, to the image reconstruction processing unit 57 via the bus 60, and causes the image reconstruction processing unit 57 to perform an image reconstruction process.

Also, the camera signal processing unit 54 can supply the image (YC) in the YC format to the through-lens image generation unit 55, for example.

Note that, in a case where an image in the RAW format (a whole image, a viewpoint image, or a partial image) is stored in the storage medium 63, the camera signal processing unit 54 may be able to read the image in the RAW format from the storage medium 63 and perform signal processing on the image. In this case, the camera signal processing unit 54 can also supply an image (YC) in the YC format subjected to the camera signal processing, to the display unit 61, the storage unit 62, the communication unit 64, the file generation unit 65, the image reconstruction processing unit 57, or the like via the bus 60.

Also, the camera signal processing unit 54 may perform camera signal processing on a captured image (a whole image) in the RAW format output from the image sensor 51, and the region extraction unit 53 may extract a partial region from the captured image (whole image) after the camera signal processing.

<Through-Lens Image Generation Unit>

The through-lens image generation unit 55 performs processes related to generation of a through-lens image. A through-lens image is an image that is displayed for the user to check an image being captured during imaging or during preparation for imaging (during a non-recording operation). A through-lens image is also referred to as a live view image or an electronic to electronic (EE) image. Note that, during still image capturing, an image before imaging is displayed. However, during moving image capturing, a through-lens image corresponding to the image being captured (recorded) as well as the image being prepared for imaging is also displayed.

For example, the through-lens image generation unit 55 can acquire an image (a whole image, a viewpoint image, or a composite image) supplied from the camera signal processing unit 54. Also, the through-lens image generation unit 55 can generate a through-lens image to be an image for display, by performing image size (resolution) conversion to convert the image size into a size compatible with the resolution of the display unit 61, for example, using the acquired image. The through-lens image generation unit 55 can supply the generated through-lens image to the display unit 61 via the bus 60, and cause the display unit 61 to display the through-lens image.

<Region Specifying Unit>

The region specifying unit 56 performs processes related to specifying (setting) of regions to be extracted from a captured image by the region extraction unit 53. For example, the region specifying unit 56 specifies viewpoint association information (VI), and supplies a viewpoint image region to the region extraction unit 53.

The viewpoint association information (VI) includes viewpoint region information indicating the viewpoint image region in a captured image, for example. The viewpoint region information may represent the viewpoint image region in any appropriate manner. For example, the viewpoint image region may be represented by the coordinates (also referred to as the center coordinates of the viewpoint image region) indicating the position corresponding to the optical axis of the monocular optical system 31 in the captured image, and the resolution (the number of pixels) of the viewpoint image (viewpoint image region). That is, the viewpoint region information may include the center coordinates of the viewpoint image region in the captured image and the resolution of the viewpoint image region. In this case, the location of the viewpoint image region in the whole image can be specified from the center coordinates of the viewpoint image region and the resolution (the number of pixels) of the viewpoint image region.

Note that the viewpoint region information is set for each viewpoint image region. That is, in a case where the captured image includes a plurality of viewpoint images, the viewpoint association information (VI) may include, for each viewpoint image (each viewpoint image region), viewpoint identification information (an identification number, for example) for identifying the viewpoint image (region) and viewpoint region information.

The viewpoint association information (VI) may also include other relevant information. For example, the viewpoint association information (VI) may include viewpoint time information indicating the time at which the captured image from which the viewpoint image is extracted was captured. Also, the viewpoint association information (VI) may include viewpoint-image-including region information indicating the viewpoint-image-including region that is the region cut out from a monocular image and include the viewpoint image region. Further, the viewpoint association information (VI) may include spot light information (SI) that is information regarding an image of spot light formed in a region that is neither a viewpoint image region nor the region of a monocular image in the captured image.

The region specifying unit 56 supplies such viewpoint association information (VI) as information indicating the specified viewpoint image region to the region extraction unit 53, so that the region extraction unit 53 can extract the viewpoint image region specified by the region specifying unit 56 (or cut out the viewpoint image), on the basis of the viewpoint association information (VI).

The region specifying unit 56 can also supply the viewpoint association information (VI) to the bus 60. For example, the region specifying unit 56 can supply the viewpoint association information (VI) to the storage unit 62 via the bus 60, and store the viewpoint association information (VI) into the storage medium 63. Also, the region specifying unit 56 can supply the viewpoint association information (VI) to the communication unit 64 via the bus 60, and cause the communication unit 64 to transmit the viewpoint association information (VI). Further, the region specifying unit 56 can supply the viewpoint association information (VI) to the file generation unit 65 via the bus 60, and cause the file generation unit 65 to turn viewpoint association information (VI) into a file. Furthermore, the region specifying unit 56 can supply the viewpoint association information (VI) to the image reconstruction processing unit 57 via the bus 60, and cause the image reconstruction processing unit 57 to use the viewpoint association information (VI) in the image reconstruction process.

For example, the region specifying unit 56 may acquire such viewpoint association information (VI) from the control unit 81, and supply the acquired viewpoint association information (VI) to the region extraction unit 53 and the bus 60. In this case, the control unit 81 reads the viewpoint association information (VI) stored in a storage medium 83 via the storage unit 82, and supplies the viewpoint association information (VI) to the region specifying unit 56. The region specifying unit 56 supplies the viewpoint association information (VI) to the region extraction unit 53 and the bus 60. Note that the viewpoint association information (VI) may include spot light information (SI).

The viewpoint association information (VI) supplied to the storage unit 62, the communication unit 64, or the file generation unit 65 via the bus 60 in this manner is associated with an image (the whole image, a viewpoint image, or a composite image) therein. For example, the storage unit 62 can associate the supplied viewpoint association information (VI) with an image (the whole image, a viewpoint image, or a composite image), and store the information associated with the image into the storage medium 63. Also, the communication unit 64 can associate the supplied viewpoint association information (VI) with an image (the whole image, a viewpoint image, or a composite image), and transmit the information associated with the image to the outside. Further, the file generation unit 65 can associate the supplied viewpoint association information (VI) with an image (the whole image, a viewpoint image, or a composite image), and generate a file containing the information associated with the image.

The region specifying unit 56 may also acquire a captured image in the RAW format supplied from the image sensor 51, generate viewpoint association information (VI′) on the basis of the captured image, and supply the generated viewpoint association information (VI′) to the region extraction unit 53 and the bus 60. In this case, the region specifying unit 56 specifies each viewpoint image region from the captured image, and generates the viewpoint association information (VI′) indicating the viewpoint image region (the viewpoint image region is indicated by the center coordinates of the viewpoint image region in the captured image, the resolution of the viewpoint image region, and the like, for example). The region specifying unit 56 then supplies the generated viewpoint association information (VI′) to the region extraction unit 53 and the bus 60. Note that the viewpoint association information (VI′) may include spot light information (SI′) that has been generated by the region specifying unit 56 on the basis of the captured image.

Further, the region specifying unit 56 may acquire the viewpoint association information (VI) from the control unit 81, acquire the captured image in the RAW format supplied from the image sensor 51, generate the spot light information (SI′) on the basis of the captured image, add the spot light information (SI′) to the viewpoint association information (VI), and supply the resultant information to the region extraction unit 53 and the bus 60. In this case, the control unit 81 reads the viewpoint association information (VI) stored in a storage medium 83 via the storage unit 82, and supplies the viewpoint association information (VI) to the region specifying unit 56. The region specifying unit 56 generates the viewpoint association information (VI′) by adding the spot light information (SI′) to the viewpoint association information (VI). The region specifying unit 56 supplies the viewpoint association information (VI′) to the region extraction unit 53 and the bus 60.

The region specifying unit 56 may also acquire the viewpoint association information (VI) from the control unit 81, acquire the captured image in the RAW format supplied from the image sensor 51, generate the spot light information (SI′) on the basis of the captured image, correct the viewpoint association information (VI) using the spot light information (SI′), and supply the corrected viewpoint association information (VI′) to the region extraction unit 53 and the bus 60. In this case, the control unit 81 reads the viewpoint association information (VI) stored in a storage medium 83 via the storage unit 82, and supplies the viewpoint association information (VI) to the region specifying unit 56. The region specifying unit 56 corrects the viewpoint association information (VI) using the spot light information (SI′), to generate the viewpoint association information (VI′). The region specifying unit 56 supplies the viewpoint association information (VI′) to the region extraction unit 53 and the bus 60.

<Image Reconstruction Processing Unit>

The image reconstruction processing unit 57 performs processes related to image reconstruction. For example, the image reconstruction processing unit 57 can acquire an image (a whole image, a viewpoint image, or a composite image) in the YC format from the camera signal processing unit 54 or the storage unit 62 via the bus 60. The image reconstruction processing unit 57 can also acquire the viewpoint association information from the region specifying unit 56 or the storage unit 62 via the bus 60.

Further, using the acquired image and the viewpoint association information associated with the acquired image, the image reconstruction processing unit 57 can generate depth information and perform image processing such as refocusing for generating (reconstructing) an image focused on the desired object, for example. In a case where viewpoint images are to be processed, for example, the image reconstruction processing unit 57 uses each viewpoint image to perform processes such as depth information generation and refocusing. Further, in a case where a captured image or a composite image is to be processed, the image reconstruction processing unit 57 extracts each viewpoint image from the captured image or the composite image, and performs processes such as depth information generation and refocusing using the extracted viewpoint images.

The image reconstruction processing unit 57 can supply the generated depth information and the refocused image as the processing results to the storage unit 62 via the bus 60, and store the processing results into the storage medium 63. The image reconstruction processing unit 57 can also supply the generated depth information and the refocused image as the processing results to the communication unit 64 via the bus 60, and cause the communication unit 64 to transmit the processing results to the outside. Further, the image reconstruction processing unit 57 can supply the generated depth information and the refocused image as the processing results to the file generation unit 65 via the bus 60, and cause the file generation unit 65 to turn the processing results into a file.

<Bus>

To the bus 60, the following components are connected: the image sensor 51, the RAW signal processing unit 52, the region extraction unit 53, the camera signal processing unit 54, the through-lens image generation unit 55, the region specifying unit 56, the image reconstruction processing unit 57, the display unit 61, the storage unit 62, the communication unit 64, and the file generation unit 65. The bus 60 functions as a transmission medium (transmission channel) of various kinds of data to be exchanged between these blocks. Note that the bus 60 may be formed with a cable, or may be formed with wireless communication.

<Display Unit>

The display unit 61 is formed with a liquid crystal panel, an organic electro-luminescence (EL) panel, or the like, for example, and is provided integrally with or separately from the housing of the camera 10. For example, the display unit 61 may be provided on the back surface of the housing of the camera 10 (on the surface opposite to the surface on which the multiple optical system 30 is provided).

The display unit 61 performs processes related to image display. For example, the display unit 61 can acquire a through-lens image in the YC format supplied from the through-lens image generation unit 55, convert the format into the RGB format, and display the resultant image in the RGB format. In addition to that, the display unit 61 can also display information such as a menu and settings of the camera 10, for example.

The display unit 61 can also acquire and display an image in the YC format (a captured image, viewpoint images, or a composite image) supplied from the storage unit 62. The display unit 61 can also acquire and display a thumbnail image in the YC format supplied from the storage unit 62. Further, the display unit 61 can acquire and display an image in the YC format (a captured image, viewpoint images, or a composite image) supplied from the camera signal processing unit 54.

<Storage Unit>

The storage unit 62 controls the storage in the storage medium 63, which is formed with a semiconductor memory or the like, for example. This storage medium 63 may be a removable storage medium, or may be a storage medium included in the camera 10. For example, the storage unit 62 can store, into the storage medium 63, an image (a captured image, viewpoint images, or a composite image) supplied via the bus 60, in response to an operation performed by the control unit 81, a user, or the like.

For example, the storage unit 62 can acquire an image in the RAW format (a whole image, a viewpoint image, or a composite image) supplied from the image sensor 51 or the region extraction unit 53, and store the image into the storage medium 63. The storage unit 62 can also acquire a signal-processed image in the RAW format (a whole image, a viewpoint image, or a composite image) supplied from the RAW signal processing unit 52, or a compressed (encoded) image in the RAW format (a whole image, a viewpoint image, or a composite image) supplied from the RAW signal processing unit 52, and store the image into the storage medium 63. Further, the storage unit 62 can acquire an image in the YC format (a whole image, a viewpoint image, or a composite image) supplied from the camera signal processing unit 54, and store the image into the storage medium 63.

At that time, the storage unit 62 can acquire the viewpoint association information supplied from the region specifying unit 56, and associate the viewpoint association information with the above-mentioned image (a whole image, a viewpoint image, or a composite image). That is, the storage unit 62 can associate the image (a whole image, a viewpoint image, or a composite image) and the viewpoint association information with each other, and store the image associated with the viewpoint association information into the storage medium 63. That is, the storage unit 62 functions as an association unit that associates at least one image among a whole image, a viewpoint image, and a composite image with the viewpoint association information.

For example, the storage unit 62 can also acquire the depth information and the refocused image supplied from the image reconstruction processing unit 57, and store them into the storage medium 63. Further, the storage unit 62 can acquire the file supplied from the file generation unit 65, and store the file into the storage medium 63. This file contains an image (a whole image, a viewpoint image, or a composite image) and viewpoint association information, for example. That is, in this file, the image (a whole image, a viewpoint image, or a composite image) and the viewpoint association information are associated with each other.

For example, the storage unit 62 can also read data, a file, or the like stored in the storage medium 63 in response to an operation performed by the control unit 81, a user, or the like, and supply the read data, file, or the like to the camera signal processing unit 54, the display unit 61, the communication unit 64, the file generation unit 65, the image reconstruction processing unit 57, or the like via the bus 60. For example, the storage unit 62 can read an image in the YC format (a whole image, a viewpoint image, or a composite image) from the storage medium 63, supply the image to the display unit 61, and cause the display unit 61 to display the image. The storage unit 62 can also read an image in the RAW format (a whole image, a viewpoint image, or a composite image) from the storage medium 63, supply the image to the camera signal processing unit 54, and cause the camera signal processing unit 54 to perform camera signal processing.

Further, the storage unit 62 can read data or a file of an image (a whole image, a viewpoint image, or a composite image) and viewpoint association information that are associated with each other and are stored in the storage medium 63, and supply the data or the file to another processing unit. For example, the storage unit 62 can read, from the storage medium 63, an image (a whole image, a viewpoint image, or a composite image) and viewpoint association information associated with each other, supply the image and the viewpoint association information to the image reconstruction processing unit 57, and cause the image reconstruction processing unit 57 to perform processes such as depth information generation and refocusing. Also, the storage unit 62 can read, from the storage medium 63, an image (a whole image, a viewpoint image, or a composite image) and viewpoint association information associated with each other, supply the image and the viewpoint association information to the communication unit 64, and cause the communication unit 64 to transmit the image and the viewpoint association information. Further, the storage unit 62 can read, from the storage medium 63, an image (a whole image, a viewpoint image, or a composite image) and viewpoint association information associated with each other, supply the image and the viewpoint association information to the file generation unit 65, and cause the file generation unit 65 to turn the image and the viewpoint association information into a file.

Note that the storage medium 63 may be a read only memory (ROM), or may be a rewritable memory such as a random access memory (RAM) or a flash memory. In the case of a rewritable memory, the storage medium 63 can store any information.

<Communication Unit>

The communication unit 64 communicates with a server on the Internet, a PC on a cable or wireless LAN, some other external device, or the like by an appropriate communication method. For example, the communication unit 64 can transmit data and a file of an image (a captured image, viewpoint images, or a composite image), viewpoint association information, and the like to the other side of communication (an external device) by a streaming method, an upload method, or the like through the communication, in response to control performed by the control unit 81, an operation performed by the user, or the like.

For example, the communication unit 64 can acquire and transmit an image in the RAW format (a captured image, viewpoint images, or a composite image) supplied from the image sensor 51 or the region extraction unit 53. The communication unit 64 can also acquire and transmit a signal-processed image in the RAW format (a captured image, viewpoint images, or a composite image) supplied from the RAW signal processing unit 52, or a compressed (encoded) image in the RAW format (a captured image, a viewpoint image, or a composite image) supplied from the RAW signal processing unit 52. Further, the communication unit 64 can acquire and transmit an image in the YC format (a captured image, viewpoint images, or a composite image) supplied from the camera signal processing unit 54.

At that time, the communication unit 64 can acquire the viewpoint association information supplied from the region specifying unit 56, and associate the viewpoint association information with the above-mentioned image (a whole image, a viewpoint image, or a composite image). That is, the communication unit 64 can associate the image (a whole image, a viewpoint image, or a composite image) and the viewpoint association information with each other, and transmit the image associated with the viewpoint association information. In a case where an image is to be transmitted by a streaming method, for example, the communication unit 64 repeats the process of acquiring an image to be transmitted (a whole image, a viewpoint image, or a composite image) from the processing unit that supplies the image, associating the image with the viewpoint association information supplied from the region specifying unit 56, and transmitting the image. That is, the communication unit 64 functions as an association unit that associates at least one image among a whole image, a viewpoint image, and a composite image with the viewpoint association information.

For example, the communication unit 64 can also acquire and transmit depth information and a refocused image supplied from the image reconstruction processing unit 57. Further, the communication unit 64 can acquire and transmit a file supplied from the file generation unit 65. This file contains an image (a whole image, a viewpoint image, or a composite image) and viewpoint association information, for example. That is, in this file, the image (a whole image, a viewpoint image, or a composite image) and the viewpoint association information are associated with each other.

<File Generation Unit>

The file generation unit 65 performs processes related to file generation. For example, the file generation unit 65 can acquire an image in the RAW format (a whole image, a viewpoint image, or a composite image) supplied from the image sensor 51 or the region extraction unit 53. The file generation unit 65 can also acquire a signal-processed image in the RAW format (a whole image, a viewpoint image, or a composite image) supplied from the RAW signal processing unit 52, or a compressed (encoded) image in the RAW format (a whole image, a viewpoint image, or a composite image) supplied from the RAW signal processing unit 52. Further, the file generation unit 65 can acquire and an image in the YC format (a whole image, a viewpoint image, or a composite image) supplied from the camera signal processing unit 54. Also, the file generation unit 65 can acquire viewpoint association information supplied from the region specifying unit 56, for example.

The file generation unit 65 can turn a plurality of acquired pieces of data into a file, and generate one file containing the plurality of pieces of data, to associate the plurality of pieces of data with one another. For example, the file generation unit 65 can generate one file from the above mentioned image (a whole image, a viewpoint image, or a composite image) and the viewpoint association information, to associate the image and the viewpoint association information with each other. That is, the file generation unit 65 functions as an association unit that associates at least one image among a whole image, a viewpoint image, and a composite image with the viewpoint association information.

For example, the file generation unit 65 can also acquire depth information and a refocused image supplied from the image reconstruction processing unit 57, and turn them into a file. Further, the file generation unit 65 can generate one file from an image (a whole image, a viewpoint image, or a composite image) and viewpoint association information that are supplied from the storage unit 62 and are associated with each other.

Note that the file generation unit 65 can generate a thumbnail image of an image (a viewpoint image, for example) to be turned into a file, and put the thumbnail image into a generated file. That is, by generating a file, the file generation unit 65 can associate this thumbnail image with the image (a whole image, a viewpoint image, or a composite image) and viewpoint association information.

The file generation unit 65 can supply the generated file (the image and the viewpoint association information associated with each other) to the storage unit 62 via the bus 60, for example, and store the file into the storage medium 63. The file generation unit 65 can also supply the generated file (the image and the viewpoint association information associated with each other) to the communication unit 64 via the bus 60, for example, and cause the communication unit 64 to transmit the file.

<Association Unit>

The storage unit 62, the communication unit 64, and the file generation unit 65 are also referred to as an association unit 70. The association unit 70 associates an image (a whole image, a viewpoint image, or a composite image) with viewpoint association information. For example, the storage unit 62 can associate at least one image among a whole image, a viewpoint image, and a composite image with viewpoint association information, and store the image associated with the viewpoint association information into the storage medium 63. Also, the communication unit 64 can associate at least one image among a whole image, a viewpoint image, and a composite image with viewpoint association information, and transmit the image associated with the viewpoint association information. Further, the file generation unit 65 can generate one file from at least one image among a whole image, a viewpoint image, and a composite image, and viewpoint association information, to associate the image and the viewpoint association information with each other.

<Control Unit>

The control unit 81 performs control processes related to the camera 10. That is, the control unit 81 can control each component of the camera 10, and cause the camera 10 to perform processes. For example, the control unit 81 can control the multiple optical system 30 (each of the monocular optical systems 31) via the optical system control unit 84, and cause the multiple optical system 30 to perform the optical system settings related to imaging, such as settings of an aperture and a focus position. The control unit 81 can also control the image sensor 51 to cause the image sensor 51 to perform imaging (photoelectric conversion) and generate a captured image.

Further, the control unit 81 can supply viewpoint association information (VI) to the region specifying unit 56, and cause the region specifying unit 56 to specify the region to be extracted from the captured image. Note that the viewpoint association information (VI) may include spot light information (SI). Also, the control unit 81 may read the viewpoint association information (VI) stored in the storage medium 83 via the storage unit 82, and supply the viewpoint association information (VI) to the region specifying unit 56.

The control unit 81 can also acquire an image via the bus 60, and control the aperture via the optical system control unit 84, on the basis of the luminance of the image. Further, the control unit 81 can control the focus via the optical system control unit 84, on the basis of the sharpness of the image. Also, the control unit 81 can control the camera signal processing unit 54 on the basis of the RGB ratio of the image, to control the white balance gain.

<Storage Unit>

The storage unit 82 controls the storage in the storage medium 83, which is formed with a semiconductor memory or the like, for example. This storage medium 83 may be a removable storage medium, or may be a built-in memory. This storage medium 83 stores viewpoint association information (VI), for example. This viewpoint association information (VI) is information corresponding to (the respective monocular optical systems 31 of) the multiple optical system 30 and the image sensor 51. That is, the viewpoint association information (VI) is information regarding the viewpoint images having the respective monocular optical systems 31 of the multiple optical system 30 as the viewpoints, and is information to be used for specifying the viewpoint image regions. For example, the viewpoint association information (VI) may include spot light information (SI).

For example, the storage unit 82 can read the viewpoint association information (VI) stored in the storage medium 83 in response to an operation or the like performed by the control unit 81 or the user, and supply the viewpoint association information (VI) to the control unit 81.

Note that the storage medium 83 may be a ROM, or may be a rewritable memory such as a RAM or a flash memory. In the case of a rewritable memory, the storage medium 83 can store desired information.

Alternatively, the storage unit 82 and the storage medium 83 may be substituted by the storage unit 62 and the storage medium 63. That is, information (the viewpoint association information (VI) or the like) to be stored into the storage medium 83 described above may be stored into the storage medium 63. In that case, the storage unit 82 and the storage medium 83 are not necessarily prepared.

<Optical System Control Unit>

The optical system control unit 84 controls (the respective monocular optical systems 31 of) the multiple optical system 30, under the control of the control unit 81. For example, the optical system control unit 84 can control the lens groups and the aperture of each of the monocular optical systems 31, to control the focal length and/or the f-number of each of the monocular optical systems 31. Note that, in a case where the camera 10 has an electric focus adjustment function, the optical system control unit 84 can control the focus (focal length) of (each of the monocular optical systems 31 of) the multiple optical system 30. Also, the optical system control unit 84 may be able to control the aperture (f-number) of each of the monocular optical systems 31.

Note that, instead of such an electric focus adjustment function, the camera 10 may include a mechanism (a physical component) that adjusts the focal length by manually operating a focus ring provided on the lens barrel. In that case, the optical system control unit 84 is not necessarily prepared.

<Association with the Viewpoint Association Information>

The camera 10 can extract, from a captured image, viewpoint images having the respective monocular optical systems 31 as the viewpoints. Since the plurality of viewpoint images extracted from one captured image is images having different viewpoints, it is possible to perform processes such as depth estimation through multiple matching and correction for reducing errors in the attachment of the multiple lenses, for example, using these viewpoint images. However, to perform these processes, information such as the relative positions of the respective viewpoint images is necessary.

Therefore, the camera 10 associates the viewpoint association information, which is the information to be used for specifying the regions of the plurality of viewpoint images in the captured image, with the whole image, the viewpoint image, or the composite image to be output.

Here, the term “to associate” means to enable use of other data (or a link to other data) while data is processed, for example. That is, the captured image and the viewpoint association information as data (files) may be in any appropriate form. For example, the captured image and the viewpoint association information may be integrated as one set of data (one file), or may be separately collected as data (files). For example, the viewpoint association information associated with the captured image may be transmitted through a transmission channel different from that for the captured image.

Alternatively, the viewpoint association information associated with the captured image may be recorded in a recording medium different from the captured image (or in a different recording area of the same recording medium), for example. The captured image and the viewpoint association information may of course be combined into one stream data, or may be integrated into one file.

Note that the image with which the viewpoint association information is associated may be a still image or a moving image. In the case of a moving image, region extraction, association with viewpoint association information, and the like can be performed for each frame image, as in the case of a still image.

Also, this “association” may apply to some of the data, instead of the entire data. For example, in a case where the captured image is a moving image formed with a plurality of frames, the viewpoint association information may be associated with any units in the captured image, such as a plurality of frames, one frame, or a portion in a frame.

Note that, in a case where the captured image and the viewpoint association information are individual pieces of data (files), it is possible to associate the captured image and the viewpoint association information with each other by assigning the same identification number to both the captured image and the viewpoint association information. Alternatively, in a case where the captured image and the viewpoint association information are combined into one file, the viewpoint association information may be added to the header or the like of the captured image, for example. Note that the image to be associated with the viewpoint association information may be the captured image (the whole image), a viewpoint image, or a composite image of viewpoint images.

<Outputting of a Whole Image>

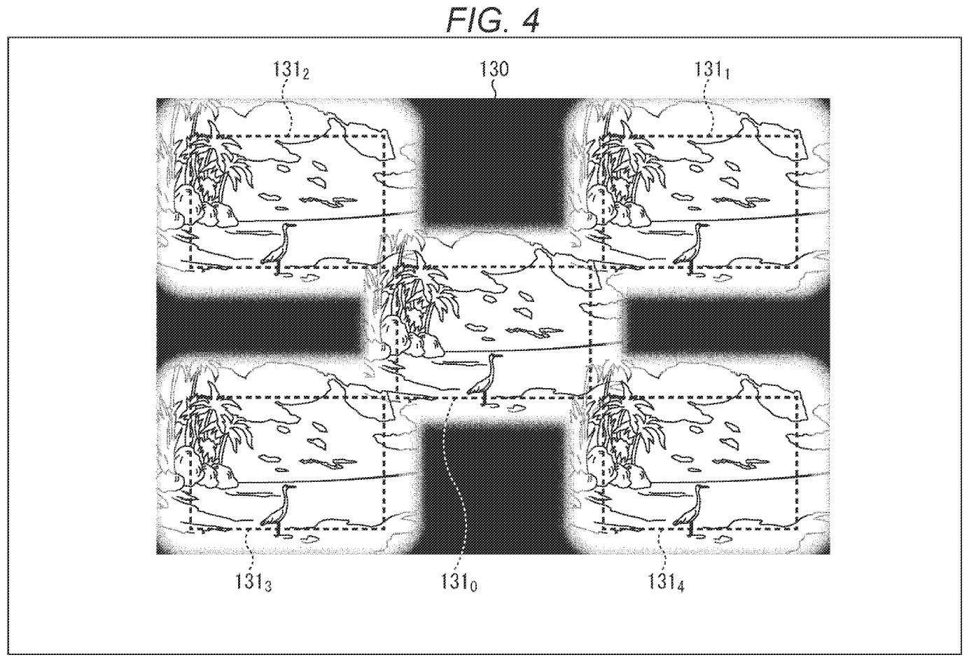

A case where a whole image is to be output is now described. FIG. 4 shows an example of a whole image. As shown in FIG. 4, a whole image 130 includes monocular images corresponding to the respective monocular optical systems 31 (images obtained by photoelectrically converting light entering from the object through the respective monocular optical systems 31). For example, the image at the center of the whole image 130 is the monocular image corresponding to the monocular optical system 31₀. Also, the upper right image in the whole image 130 is the monocular image corresponding to the monocular optical system 31₁. Further, the upper left image in the whole image 130 is the monocular image corresponding to the monocular optical system 31₂. Also, the lower left image in the whole image 130 is the monocular image corresponding to the monocular optical system 31₃. Further, the lower right image in the whole image 130 is the monocular image corresponding to the monocular optical system 31₄.

Note that this whole image 130 may be an entire captured image generated by the image sensor 51, or may be a partial image that is cut out from the captured image (but includes all the monocular images). Alternatively, this whole image 130 may be an image in the RAW format, or may be an image in the YC format.

The viewpoint region information specifies a portion (the effective portion) of each of the monocular images as the viewpoint image regions in the whole image 130. For example, in the case illustrated in FIG. 4, the regions surrounded by dashed-line frames in the whole image 130 is the viewpoint image regions. That is, a portion (the effective portion) of the monocular image corresponding to the monocular optical system 31₀ is designated as a viewpoint image region 131₀. Likewise, a portion (the effective portion) of the monocular image corresponding to the monocular optical system 31₁ is designated as a viewpoint image region 131₁. Also, a portion (the effective portion) of the monocular image corresponding to the monocular optical system 31₂ is designated as a viewpoint image region 131₂. Further, a portion (the effective portion) of the monocular image corresponding to the monocular optical system 31₃ is designated as a viewpoint image region 131₃. Also, a portion (the effective portion) of the monocular image corresponding to the monocular optical system 31₄ is designated as a viewpoint image region 131₄. Note that, in the description below, the viewpoint image regions 131₀ to 131₄ will be referred to as the viewpoint image regions 131 in a case where there is no need to distinguish the viewpoint image regions from one another.

In a case where such a whole image 130 is to be output, the association unit 70 acquires the whole image 130 from the image sensor 51, the RAW signal processing unit 52, or the camera signal processing unit 54, and associates the whole image 130 with the viewpoint association information that is supplied from the region specifying unit 56 and corresponds to the multiple optical system 30. The association unit 70 then outputs the whole image and the viewpoint association information associated with each other. In an example of the output, the storage unit 62 may store the whole image and the viewpoint association information associated with each other into the storage medium 63, for example. Also, the communication unit 64 may transmit the whole image and the viewpoint association information associated with each other. Further, the file generation unit 65 may turn the whole image and the viewpoint association information associated with each other into a file.

Note that the association between the whole image and the viewpoint association information may be performed by the region extraction unit 53. That is, the region extraction unit 53 may associate the whole image to be output with the viewpoint association information supplied from the region specifying unit 56, and supply the whole image and the viewpoint association information associated with each other to the bus 60, the RAW signal processing unit 52, or the camera signal processing unit 54.

The viewpoint association information in this case includes the viewpoint region information indicating the plurality of viewpoint image regions in the captured image. The viewpoint region information may represent the viewpoint image region in any appropriate manner. For example, a viewpoint image region may be represented by the coordinates (the center coordinates of the viewpoint image region) indicating the position corresponding to the optical axis of the monocular optical system 31 in the captured image, and the resolution (the number of pixels) of the viewpoint image (viewpoint image region). That is, the viewpoint region information may include the center coordinates of the viewpoint image region in the captured image and the resolution of the viewpoint image region. In this case, the locations of the viewpoint image regions in the whole image 130 can be specified from the center coordinates of the viewpoint image regions and the resolutions (the numbers of pixels) of the viewpoint image regions.

By associating the captured image with such viewpoint association information, it is possible to use this viewpoint association information in the viewpoint image extraction as the preprocessing for processes in later stages, such as depth estimation through multiple matching, and reduction of errors that might occur during the attachment (installation) of the multiple optical system 30. For example, after extracting each viewpoint image on the basis of the viewpoint region information included in the viewpoint association information, the image reconstruction processing unit 57 can perform the processes in later stages, such as depth estimation through multiple matching, a refocusing process, and a process for reducing errors that might occur during the attachment (installation) of the multiple optical system 30.

Note that, even if the whole image 130 is not associated with the viewpoint association information, the image reconstruction processing unit 57 may be able to specify the viewpoint image regions included in the whole image 130 through image processing, for example. However, it might be difficult to accurately specify the viewpoint image regions in the captured image, depending on imaging conditions or the like. Therefore, the whole image 130 is associated with the viewpoint association information as described above, so that the image reconstruction processing unit 57 can more easily and more accurately extract the viewpoint image regions from the whole image 130, on the basis of the viewpoint association information.

<Outputting of Viewpoint Images>

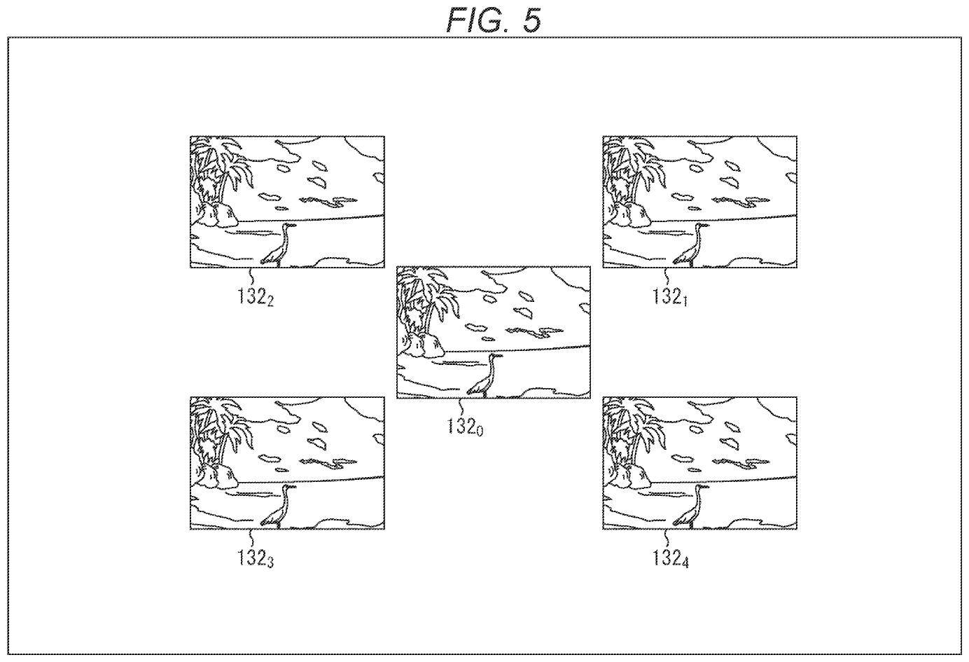

Next, a case where viewpoint images are to be output is described. FIG. 5 is a diagram showing an example of cutout viewpoint images. In FIG. 5, a viewpoint image 132₀ is the image obtained by extracting the viewpoint image region 131₀ from the whole image 130 (FIG. 4). A viewpoint image 132₁ is the image obtained by extracting the viewpoint image region 131₁ from the whole image 130. A viewpoint image 132₂ is the image obtained by extracting the viewpoint image region 131₂ from the whole image 130. A viewpoint image 132₃ is the image obtained by extracting the viewpoint image region 131₃ from the whole image 130. A viewpoint image 132₄ is the image obtained by extracting the viewpoint image region 131₄ from the whole image 130. Note that, in the description below, the viewpoint images 132₀ to 132₄ will be referred to as the viewpoint images 132 in a case where there is no need to distinguish the viewpoint images from one another.

In a case where such viewpoint images are to be output, the region extraction unit 53 outputs each viewpoint image 132 cut out as in the example shown in FIG. 5 as an independent piece of data (or a file).

For example, the region extraction unit 53 cuts out the viewpoint images from the captured image (whole image) in accordance with the viewpoint association information supplied from the region specifying unit 56. The region extraction unit 53 assigns, to each cutout viewpoint image, viewpoint identification information (identification numbers, for example) for identifying each viewpoint. The region extraction unit 53 supplies the camera signal processing unit 54 with each viewpoint image to which the viewpoint identification information is assigned. The camera signal processing unit 54 performs camera signal processing on each viewpoint image in the RAW format, to generate each viewpoint image in the YC format. The camera signal processing unit 54 supplies the association unit 70 with each viewpoint image in the YC format. Further, the region specifying unit 56 supplies the association unit 70 with the viewpoint association information supplied to the region extraction unit 53.

The association unit 70 associates each viewpoint image with the viewpoint association information corresponding to the viewpoint image. The viewpoint association information may include the viewpoint identification information (the viewpoint identification number, for example) for identifying each viewpoint. On the basis of this viewpoint identification information, the association unit 70 associates each viewpoint image with the viewpoint association information corresponding to the viewpoint image. By referring to this viewpoint identification information, the association unit 70 can easily grasp which viewpoint association information corresponds to which viewpoint image. That is, using this viewpoint identification information, the association unit 70 can correctly associate each viewpoint image with the viewpoint association information more easily.

The association unit 70 then outputs each viewpoint image and the viewpoint association information associated with each other. For example, the storage unit 62 may store each viewpoint image and the viewpoint association information associated with each other into the storage medium 63. Also, the communication unit 64 may transmit each viewpoint image and the viewpoint association information associated with each other. Further, the file generation unit 65 may turn each viewpoint image and the viewpoint association information associated with each other into a file.

Note that the association between each viewpoint image and the viewpoint association information may be performed by the region extraction unit 53. That is, the region extraction unit 53 may associate each viewpoint image to be output with the viewpoint association information supplied from the region specifying unit 56, and supply each viewpoint image and the viewpoint association information associated with each other to the bus 60, the RAW signal processing unit 52, or the camera signal processing unit 54.

Further, the viewpoint association information may include viewpoint time information indicating the time at which the captured image from which the viewpoint images are extracted was captured, and the order in which the viewpoint images are extracted. In a case where viewpoint images extracted from a plurality of captured images coexist, or where the viewpoint images are moving images or continuous images, it might be difficult to identify which viewpoint image is extracted from which captured image. By associating the viewpoint images with the viewpoint time information indicating the times of generation and the order of the captured images, it is possible to more easily identify the captured images corresponding to the respective viewpoint images (the captured images from which the respective viewpoint images are extracted). In other words, it is possible to more easily specify a plurality of viewpoint images extracted from the same captured image. Additionally, even in a case where recorded files are not comprehensively managed, it is possible to specify each viewpoint image at the same time.

Note that, monocular images may be cut out from a captured image, and be processed or recorded, as in the case of viewpoint images.

<Outputting of a Composite Image>

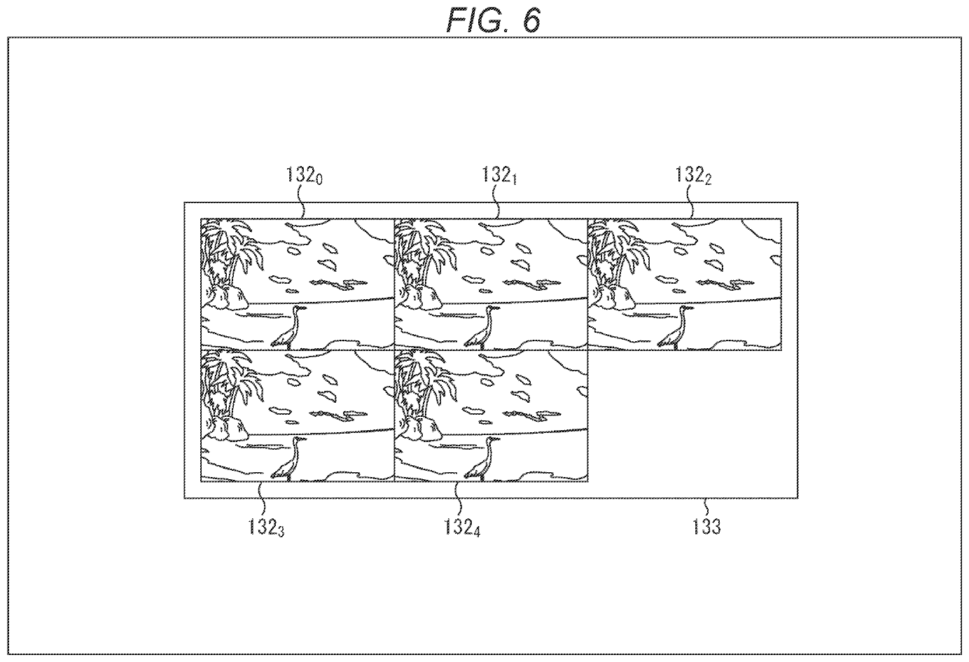

Next, a case where a composite image is to be output is described. FIG. 6 is a diagram showing an example of a composite image obtained by combining the respective viewpoint images. In the example case shown in FIG. 6, one composite image 133 is generated by combining the viewpoint images 132₀ to 132₄ extracted in the example shown in FIG. 5 so as to be displayed side by side in one image. That is, the composite image 133 is obtained by combining the respective viewpoint images 132 into one set of data (one frame) or one file.

Note that, in FIG. 6, a margin region is shown around the viewpoint images 132₀ to 132₄ of the composite image 133. However, the composite image 133 may or may not have this margin region. Further, the shape of the composite image 133 is only required to be rectangular, and the method for arranging (laying out) the respective viewpoint images 132 may be any appropriate method. As in the example shown in FIG. 6, a blank region (the region corresponding to the sixth viewpoint image 132) generated in a case where the five viewpoint images 132 are arranged in two rows and three columns may be expressed by null data or a fixed value.

For example, the region extraction unit 53 cuts out the viewpoint images from the captured image (whole image) in accordance with the viewpoint association information supplied from the region specifying unit 56. The region extraction unit 53 generates a composite image by combining the respective cutout viewpoint images so as to be displayed side by side in one image. At that time, by determining the alignment sequence (positions) of the respective viewpoint images beforehand, it is possible to easily grasp which viewpoint each of the viewpoint images included in the composite image has.

Alternatively, the combining may be performed after viewpoint identification information (an identification numbers, for example) is assigned to each viewpoint image. In this case, it is also possible to easily grasp which viewpoint each viewpoint image included in the composite image has. In the description below, the alignment sequence of the respective viewpoint images in the composite image is determined in advance.

The region extraction unit 53 supplies the camera signal processing unit 54 with the composite image to which the viewpoint identification information is assigned. The camera signal processing unit 54 performs camera signal processing on the composite image in the RAW format, to generate a composite image in the YC format. The camera signal processing unit 54 supplies the association unit 70 with the composite image in the YC format. Further, the region specifying unit 56 supplies the association unit 70 with the viewpoint association information supplied to the region extraction unit 53.

The association unit 70 associates the composite image with the viewpoint association information. The viewpoint of each viewpoint image included in the composite image is more apparent from the position of the viewpoint image in the composite image. That is, it is possible to easily grasp to which viewpoint region information in the viewpoint association information each viewpoint image corresponds.

The association unit 70 then outputs the composite image and the viewpoint association information associated with each other. For example, the storage unit 62 may store the composite image and the viewpoint association information associated with each other into the storage medium 63. Also, the communication unit 64 may transmit the composite image and the viewpoint association information associated with each other. Further, the file generation unit 65 may turn the image and the viewpoint association information associated with each other into a file.

Note that the association between the composite image and the viewpoint association information may be performed by the region extraction unit 53. That is, the region extraction unit 53 may associate the composite image to be output with the viewpoint association information supplied from the region specifying unit 56, and supply the composite image and the viewpoint association information associated with each other to the bus 60, the RAW signal processing unit 52, or the camera signal processing unit 54.

<Imaging Mode Control>

Next, an example of processes to be performed by the control unit 81 is described. For example, the control unit 81 can designate an imaging mode, and control the image sensor 51 to perform imaging in the designated imaging mode.

For example, the control unit 81 designates the imaging mode, on the basis of an instruction input from the user or the like via an input unit (not shown). For example, the control unit 81 selects the desired imaging mode from a plurality of candidates prepared in advance. These candidates may include any imaging modes. For example, a still image capturing mode for generating a captured image of a still image and a moving image capturing mode for generating a captured image of a moving image may be included. In the description below, the two imaging modes, which are the still image capturing mode and the moving image capturing mode, are prepared as the candidates, for ease of explanation.

When an imaging mode is designated (selected), the control unit 81 controls and causes the image sensor 51 to perform imaging in the designated imaging mode and generate a captured image. That is, the control unit 81 selects the still image capturing mode or the moving image capturing mode in which imaging is to be performed, and causes the image sensor to perform imaging in the selected imaging mode.

<Setting of Viewpoint Image Regions>

Also, the control unit 81 can perform processes related to setting of viewpoint image regions. For example, the control unit 81 can set viewpoint image regions corresponding to the imaging mode set as described above (which is the imaging mode for the imaging to be performed by the image sensor 51). At that time, the control unit 81 can supply the region specifying unit 56 with the viewpoint association information VI including viewpoint region information that defines the set viewpoint image regions.

The method for setting the viewpoint image regions may be any appropriate method. For example, the control unit 81 may set the viewpoint image regions corresponding to the set imaging mode, by selecting and reading (acquiring), via the storage unit 82, the viewpoint region information corresponding to the set imaging mode from the viewpoint region information about the respective imaging modes stored in the storage medium 83.

<Viewpoint Region Information>

The storage medium 83 can store the viewpoint region information that is set for each imaging mode. For example, the storage medium 83 can store still image capturing mode viewpoint region information that is the viewpoint region information to be used in imaging in the still image capturing mode, and moving image capturing mode viewpoint region information that is the viewpoint region information to be used in imaging in the moving image capturing mode.

For example, in the still image capturing mode viewpoint region information, each viewpoint image region is defined so that viewpoint images in the still image capturing mode can be obtained. Also, in the moving image capturing mode viewpoint region information, each viewpoint image region is defined so that viewpoint images in the moving image capturing mode can be obtained. The viewpoint region information will be described later in detail.

Note that the storage medium 83 can store the viewpoint region information corresponding to any desired imaging mode. For example, the viewpoint region information corresponding to the candidate imaging modes is stored beforehand in the storage medium 83, and the storage unit 82 can read the viewpoint region information corresponding to the imaging mode designated by the control unit 81 from the stored viewpoint region information, and supply the read viewpoint region information to the control unit 81.

For example, a plurality of moving image capturing modes having different aspect ratios may exist as imaging modes of the camera 10, and the storage medium 83 may store the viewpoint region information corresponding to these respective moving image capturing modes. Also, a plurality of still image capturing modes having different aspect ratios may exist as imaging modes of the camera 10, for example, and the storage medium 83 may store the viewpoint region information corresponding to these respective still image capturing modes. Further, a portrait imaging mode in which a captured image is rotated 90 degrees depending on the posture of the camera 10 may exist as an imaging mode of the camera 10, for example, and the storage medium 83 may store viewpoint region information corresponding to the portrait imaging mode.

<Viewpoint Image Region Control in Accordance with Imaging Mode>

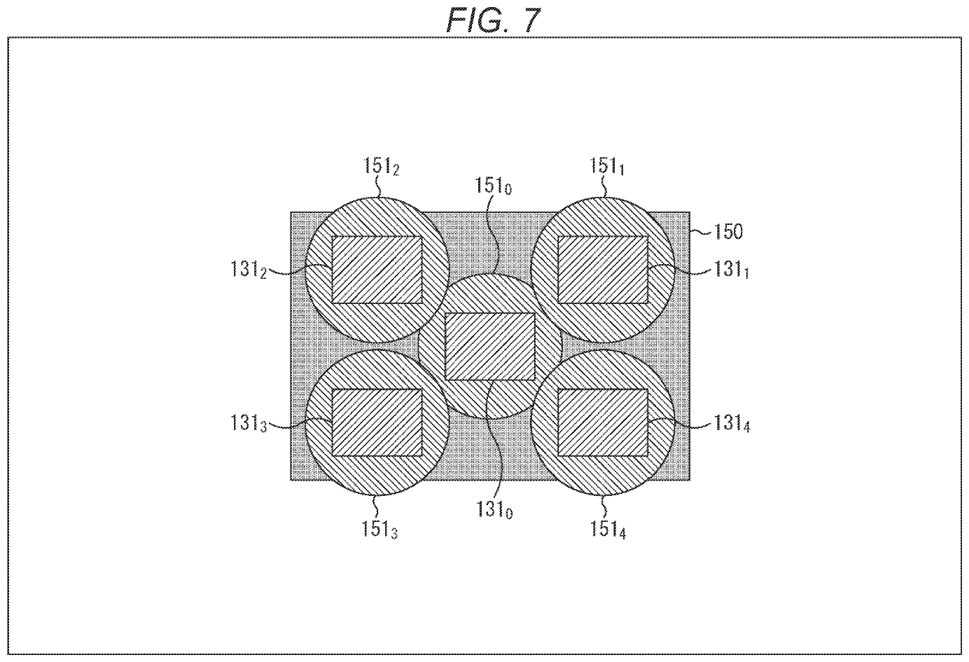

Here, the viewpoint image regions are described. Light that travels from the object through the respective monocular optical systems 31 irradiates the effective pixel region 150 of the image sensor 51, as in an example shown in FIG. 7. In FIG. 7, a monocular image region 151₀ indicates the region irradiated with light that has traveled from the object through the monocular optical system 31₀. The image of this monocular image region 151₀ is the monocular image corresponding to the monocular optical system 31₀. The viewpoint image region 131₀ is set in this monocular image region 151₀. The image of this viewpoint image region 131₀ is the viewpoint image 132₀ (FIG. 5).

Likewise, a monocular image region 151₁ indicates the region irradiated with light that has traveled from the object through the monocular optical system 31₁. The image of this monocular image region 151₁ is the monocular image corresponding to the monocular optical system 31₁. The viewpoint image region 131₁ is set in this monocular image region 151₁. The image of this viewpoint image region 131₁ is the viewpoint image 132₁ (FIG. 5).

A monocular image region 151₂ indicates the region irradiated with light that has traveled from the object through the monocular optical system 31₂. The image of this monocular image region 151₂ is the monocular image corresponding to the monocular optical system 31₂. The viewpoint image region 131₂ is set in this monocular image region 151₂. The image of this viewpoint image region 131₂ is the viewpoint image 132₂ (FIG. 5).

A monocular image region 151₃ indicates the region irradiated with light that has traveled from the object through the monocular optical system 31₃. The image of this monocular image region 151₃ is the monocular image corresponding to the monocular optical system 31₃. The viewpoint image region 131₃ is set in this monocular image region 151₃. The image of this viewpoint image region 131₃ is the viewpoint image 132₃ (FIG. 5).

A monocular image region 151₄ indicates the region irradiated with light that has traveled from the object through the monocular optical system 31₄. The image of this monocular image region 151₄ is the monocular image corresponding to the monocular optical system 31₄. The viewpoint image region 131₄ is set in this monocular image region 1514. The image of this viewpoint image region 131₄ is the viewpoint image 132₄ (FIG. 5).

Meanwhile, some conventional imaging apparatuses that generate a captured image by capturing an image of the object via an optical system that is not a multiple optical system are compatible with a plurality of imaging modes such as a still image capturing mode and a moving image capturing mode, for example. Further, in some of such imaging apparatuses, the effective pixel region of the image sensor (the aspect ratio, the resolution, or the like of a captured image) is changed in accordance with each imaging mode.

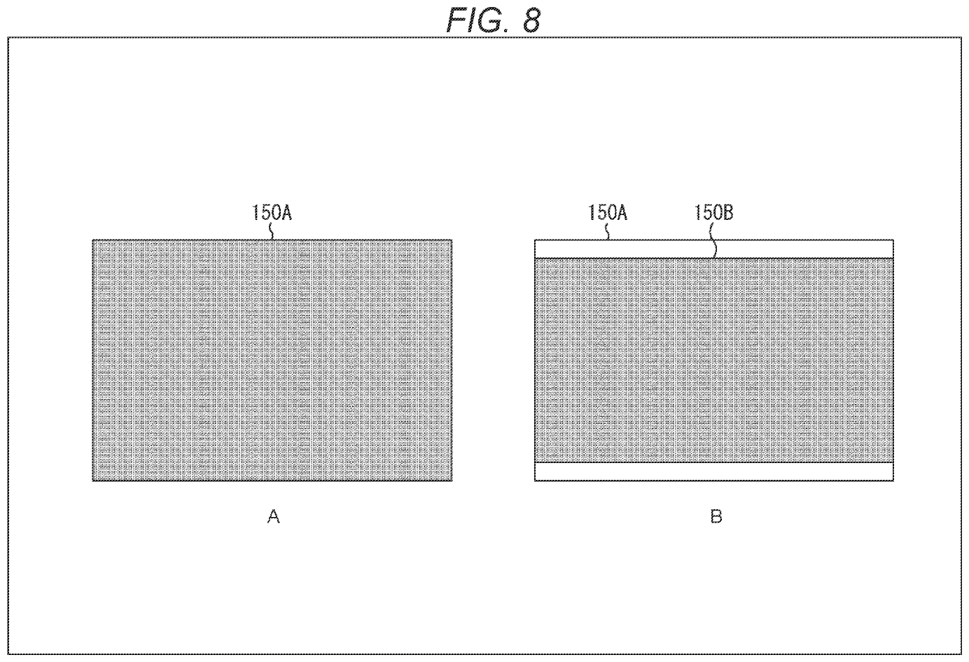

For example, in the case of the still image capturing mode in which a captured image of a still image is obtained, the effective pixel region 150 is maximized, and imaging is performed with an aspect (length-to-width) ratio of 3:2, as in an effective pixel region 150A shown in A of FIG. 8. That is, in this case, a captured image having the highest resolution with the aspect ratio of 3:2 is generated.

In the case of the moving image capturing mode, on the other hand, part of the effective pixel region 150A is cut out, and imaging is performed with an aspect (length-to-width) ratio of 16:9, as in an effective pixel region 150B shown in B of FIG. 8.

That is, in the case of such an imaging apparatus, captured images having different sizes and shapes are generated in the moving image capturing mode and the still image capturing mode.

Note that the pixel region of an image sensor normally includes an effective pixel region (also referred to as the maximum effective pixel region) that can be used for a captured image, and a non-effective pixel region that is used for optical black detection and the like. The effective pixel region 150A and the effective pixel region 150B indicate the pixel regions to be adopted as captured images in the respective imaging modes, and are regions that can be set in appropriate sizes at appropriate aspect ratios within the maximum effective pixel region mentioned above.

Likewise, in imaging using the multiple optical system 30, it is expected to change the size, the shape, and the like of each viewpoint image region (each viewpoint image) in each imaging mode.

Therefore, for a captured image generated by an image sensor that has different positions irradiated with the respective irradiation light beams having passed through a plurality of monocular optical systems that have optical paths independent of one another, viewpoint image regions that are the regions of the respective viewpoint images corresponding to the respective monocular optical systems are set in accordance with the imaging mode of the captured image.

For example, an information processing device including a setting unit that sets viewpoint image regions in accordance with the imaging mode of a captured image generated by an image sensor that has different positions irradiated with irradiation light beams having passed through a plurality of monocular optical systems that have optical paths independent of one another, the viewpoint image regions being the regions of the viewpoint images corresponding to the respective monocular optical systems.

Also, by a program, for example, a computer is made to function as a setting unit that sets viewpoint image regions in accordance with the imaging mode of a captured image generated by an image sensor that has different positions irradiated with irradiation light beams having passed through a plurality of monocular optical systems that have optical paths independent of one another, the viewpoint image regions being the regions of the viewpoint images corresponding to the respective monocular optical systems.

For example, the control unit 81 functions as such a setting unit, and sets viewpoint image regions in accordance with the imaging mode. By doing so, it is possible to obtain viewpoint images compatible with the imaging mode.

Also, a captured image is generated by photoelectrically converting irradiation light beams in a predetermined imaging mode, the respective irradiation light beams having passed through a plurality of monocular optical systems that have optical paths independent of one another. For the generated captured image, viewpoint image regions that are the regions of the respective viewpoint images corresponding to the respective monocular optical systems are set in accordance with the imaging mode.

For example, an imaging apparatus includes: an imaging unit that generates a captured image by photoelectrically converting, in a predetermined imaging mode, irradiation light beams having passed through a plurality of monocular optical systems that have optical paths independent of one another; and a setting unit that sets, in accordance with the imaging mode, viewpoint image regions for the captured image generated by the imaging unit, the viewpoint image regions being the regions of the viewpoint images corresponding to the respective monocular optical systems.

Also, by a program, for example, a computer is made to function as: an imaging unit that generates a captured image by photoelectrically converting, in a predetermined imaging mode, irradiation light beams having passed through a plurality of monocular optical systems that have optical paths independent of one another; and a setting unit that sets, in accordance with the imaging mode, viewpoint image regions for the captured image generated by the imaging unit, the viewpoint image regions being the regions of the viewpoint images corresponding to the respective monocular optical systems.

For example, the image sensor 51 functions as such an imaging unit, and images the object in the desired imaging mode via the multiple optical system 30. The control unit 81 functions as such a setting unit, and sets viewpoint image regions in accordance with the imaging mode. By doing so, it is possible to image the object from a plurality of viewpoints in the desired imaging mode, and obtain viewpoint images compatible with the imaging mode.

The parameter related to the viewpoint image regions to be set in accordance with the imaging mode may be any parameter related to the size or the shape of the viewpoint images (or the viewpoint image regions). For example, the viewpoint image regions may be set on the basis of the aspect ratio that is set in accordance with the imaging mode. By doing so, it is possible to obtain viewpoint images with an aspect ratio compatible with the imaging mode.

Also, the viewpoint image regions may be set on the basis of the resolution that is set in accordance with the imaging mode, for example. By doing so, it is possible to obtain viewpoint images with a resolution compatible with the imaging mode.

The parameter related to the viewpoint image regions to be set in accordance with the imaging mode is of course not limited to the above examples. Further, there may be a plurality of such parameters. For example, both the aspect ratio and the resolution of the region of the viewpoint images may be set in accordance with the imaging mode. By doing so, it is possible to obtain viewpoint images with an aspect ratio and a resolution compatible with the imaging mode.

<Viewpoint Region Information>

Next, the viewpoint region information indicating the viewpoint image regions is described. The control unit 81 can set the viewpoint image regions by supplying the region specifying unit 56 with the viewpoint association information including the viewpoint region information. That is, the control unit 81 can set the viewpoint image regions compatible with the adopted imaging mode by selecting the viewpoint region information corresponding to the imaging mode.

This viewpoint region information is only required to indicate the coordinates of a predetermined position in a viewpoint image. For example, the size and the shape of viewpoint image regions (or viewpoint images) are determined in advance in the system (or are grasped by the system). In this case, the coordinates of a predetermined position (the upper right end, the lower left end, the center (gravity center), or the like, for example) in a viewpoint image in the captured image (the effective pixel region of the image sensor 51) are designated, so that the range of viewpoint image regions can be designated.

In a case where the size and the shape of the viewpoint image regions vary with each imaging mode, the coordinates of the predetermined position in each viewpoint image can also vary with each imaging mode.

Therefore, in a case where the size and shape of the viewpoint image regions corresponding to the respective imaging modes are known in the system, for example, the viewpoint region information about each imaging mode is only required to indicate the coordinates of the predetermined position in each viewpoint image of the size and the shape corresponding to the imaging mode. For example, the still image capturing mode viewpoint region information is only required to indicate the coordinates to be used in the still image capturing mode at the predetermined position in each viewpoint image.

Likewise, the moving image capturing mode viewpoint region information is only required to indicate the coordinates to be used in the moving image capturing mode at the predetermined position in each viewpoint image.

In this case, the control unit 81 can designate the coordinates of the predetermined position in each viewpoint image corresponding to the adopted imaging mode by selecting the viewpoint region information corresponding to the imaging mode. Since the size and the shape of each viewpoint image are known as described above, the control unit 81 can set the viewpoint image regions corresponding to the imaging mode.

The size and the shape of the viewpoint images may of course also be defined by the viewpoint region information. That is, in this case, not only the coordinates of the predetermined position in each viewpoint image but also the size and the shape of each viewpoint image are designated in the viewpoint region information about each imaging mode. That is, the control unit 81 can designate not only the coordinates of the predetermined position in each viewpoint image corresponding to the imaging mode but also the size and the shape of each viewpoint image, by selecting the viewpoint region information corresponding to the imaging mode. Accordingly, in this case, even if the size and the shape of the viewpoint image regions are unknown in the system, the control unit 81 can set the viewpoint image regions corresponding to the imaging mode by selecting the viewpoint region information corresponding to the imaging mode.

The shape of the viewpoint images (viewpoint image regions) may be represented by an “aspect (length-to-width) ratio” of the viewpoint images (viewpoint image regions), for example. The aspect ratio of the viewpoint images in the still image capturing mode may be set to 3:2, and the aspect ratio of the viewpoint images in the moving image capturing mode may be set to 16:9, for example. The aspect ratio in each imaging mode may of course be set as appropriate, and is not limited to this example. For example, the aspect ratio may be 4:3, 1.85:1, 2.35:1, 16:10, or the like, or may be other than these. That is, the aspect ratio of each viewpoint image may be indicated in the viewpoint region information.

Also, the shape of the viewpoint images (viewpoint image regions) may be represented by a “resolution” of the viewpoint images (viewpoint image regions), for example. Since the pixel pitch is a fixed value in the pixel region, a “resolution” mentioned herein is information indicating the size of an image (region). Specifically, the information may be any kind of information. For example, the information may indicate the length (the number of pixels) of a diagonal line or the length (the number of pixels) of one side (vertical or horizontal) of a rectangular viewpoint image (viewpoint image region). Further, this value may be an absolute value, or may be a relative value with respect to a predetermined reference.

Note that some pixels in the region may be eliminated, as in an interlace system, for example. In that case, information regarding such decimation (such as information indicating whether or not to decimate pixels, and information indicating which pixels are to be eliminated, for example) may be included in this “resolution”.

### Specific Examples of the Viewpoint Image Regions in Each Imaging Mode

<In a Case where Regions Outside the Effective Pixel Region are Included>

Next, specific examples of the viewpoint image regions in the respective imaging modes as described above are described. Note that, in these examples, the image sensor 51 is compatible with the still image capturing mode or the moving image capturing mode (can perform imaging in those imaging modes). Also, the effective pixel region of the image sensor 51 is set as in the example shown in FIG. 8 in each imaging mode. More specifically, in the case of the still image capturing mode, the maximum effective pixel region 150A having an aspect ratio of 3:2 is set (A of FIG. 8). Also, in the case of the moving image capturing mode, the effective pixel region 150B that has an aspect (length-to-width) ratio of 16:9 and is narrower than the effective pixel region 150A (the upper and lower partial regions of the effective pixel region 150A are set as ineffective pixel regions) is set (B of FIG. 8).

The imaging mode may of course be any appropriate mode, and may be other than the still image capturing mode and the moving image capturing mode. Further, the effective pixel region may have any appropriate size and shape, and are not limited to the above example. For example, the size and the shape of the effective pixel region may be the same in each imaging mode.

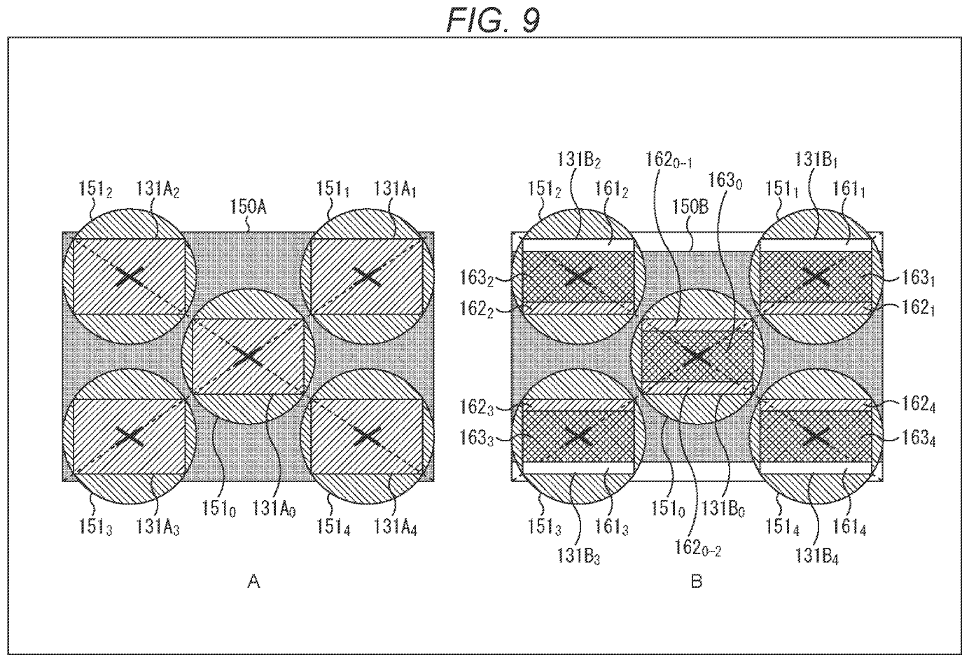

FIG. 9 shows an example of the viewpoint image regions in the respective imaging modes in a case where the viewpoint image regions may include regions outside the effective pixel region. A of FIG. 9 is a diagram showing an example of the viewpoint image regions and the like in the still image capturing mode in that case. For example, when the control unit 81 selects the still image capturing mode viewpoint region information, the viewpoint image regions shown in A of FIG. 9 are set.

As shown in A of FIG. 9, in the effective pixel region 150A, the monocular image regions 151₀ to 151₄ are formed. Viewpoint image regions 131A (viewpoint image regions 131A₀ to 131A₄) having the size and the shape adopted in the still image capturing mode are then set in the respective monocular image regions 151. The aspect ratio of the viewpoint image regions 131A is 3:2, for example. The positions of the respective viewpoint image regions 131A are designated by the coordinates of the respective centers (the intersections of diagonal lines as indicated by cross marks in the drawing).

B of FIG. 9 is a diagram showing an example of the viewpoint image regions and the like in the moving image capturing mode. For example, when the control unit 81 selects the moving image capturing mode viewpoint region information, the viewpoint image regions shown in B of FIG. 9 are set.

Since the position of the optical axis of each monocular optical system 31 is fixed regardless of the imaging mode, light that has traveled from the object through the respective monocular optical systems 31 irradiates the same position on the light receiving surface of the image sensor 51, regardless of the imaging mode. Accordingly, as shown in B of FIG. 9, in the effective pixel region 150B, the monocular image regions 151₁ to 151₄ are formed at the same positions as those in the case shown in A of FIG. 9, and viewpoint image regions 131B (viewpoint image regions 131B₀ to 131B₄) having the size and the shape adopted in the moving image capturing mode are set in the respective monocular image regions. The positions of the respective viewpoint image regions 131B are designated at the same positions as those of the viewpoint image regions 131A.

Here, as shown in B of FIG. 9, for example, part of the upper portion of the viewpoint image region 131Bᵢ is located outside the effective pixel region 150B, and forms a defective region 161₁. Likewise, part of the upper portion of the viewpoint image region 131B₂ is also located outside the effective pixel region 150B, and forms a defective region 161₂. Also, part of the lower portion of the viewpoint image region 131B₃ is located outside the effective pixel region 150B, and forms a defective region 161₃. Likewise, part of the lower portion of the viewpoint image region 131B₄ is also located outside the effective pixel region 150B, and forms a defective region 161₄.

In this case, these defective regions 161₀ to 161₄ cannot be used in multiple matching or the like, which is the matching for generating depth information using each viewpoint image. That is, the common regions among the respective viewpoint image regions 131 (the regions existing in all the viewpoint image regions 131) are actual resolution regions that can be used in the multiple matching or the like.

For example, in B of FIG. 9, an actual resolution region 163₀ is the region obtained by removing a partial region 162₀₋₁ and a partial region 162₀₋₂ from the viewpoint image region 131B₀. The partial region 162₀₋₁ is a region having the same position and size as the defective region 161₁ and the defective region 161₂. The partial region 162₀₋₂ is a region having the same position and size as the defective region 161₃ and the defective region 161₄.

Also, an actual resolution region 163₁ is the region obtained by removing the defective region 161₁ and a partial region 162₁ from the viewpoint image region 131B₁. The partial region 162₁ is a region having the same position and size as the defective region 161₃ and the defective region 161₄.

Further, an actual resolution region 163₂ is the region obtained by removing the defective region 161₂ and a partial region 162₂ from the viewpoint image region 131B₂. The partial region 162₂ is a region having the same position and size as the defective region 161₃ and the defective region 161₄.

Also, an actual resolution region 163₃ is the region obtained by removing a partial region 162₃ and the defective region 161₃ from the viewpoint image region 131B₃. The partial region 162₃ is a region having the same position and size as the defective region 161₁ and the defective region 161₂.

Further, an actual resolution region 163₄ is the region obtained by removing a partial region 162₄ and the defective region 161₄ from the viewpoint image region 131B₄. The partial region 162₄ is a region having the same position and size as the defective region 161₁ and the defective region 161₂.

Therefore, in such a case, the size and the shape of the viewpoint image regions 131B are set so that images having the desired size and shape can be obtained in the actual resolution regions. For example, in a case where images with the desired resolution and an aspect ratio of 16:9 are required as a the viewpoint images that can be used in multiple matching or the like, the aspect ratio and the resolution of the viewpoint image regions 131B should be designed so that such images can be obtained in the actual resolution regions. In other words, moving image capturing mode viewpoint region information indicating the viewpoint image regions 131B having such an aspect ratio and such a resolution should be generated. That is, such moving image capturing mode viewpoint region information should be stored in the storage medium 83, and the control unit 81 should select the moving image capturing mode viewpoint region information in the moving image capturing mode.

By doing so, it is possible to obtain viewpoint images compatible with the imaging mode.

<Flow in an Imaging Process>

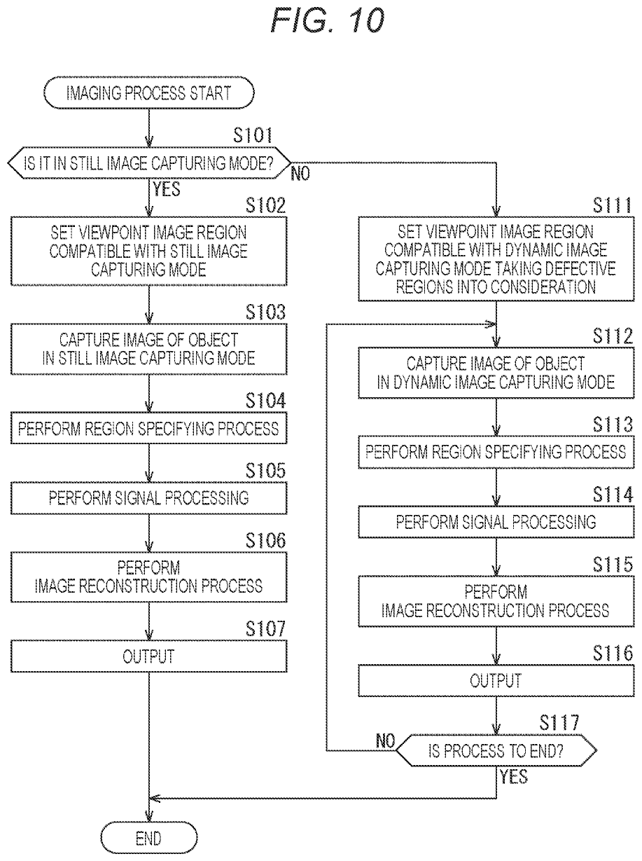

When an instruction to image the object is issued, the camera 10 performs an imaging process, and starts imaging compatible with the imaging mode. Referring now to a flowchart shown in FIG. 10, an example flow in the imaging process in this case is described.

When the imaging process is started, the control unit 81 in step S101 determines whether or not the imaging mode is the still image capturing mode. If the imaging mode is determined to be the still image capturing mode, the process moves on to step S102.

In step S102, the control unit 81 sets the viewpoint image regions corresponding to the still image capturing mode. For example, the control unit 81 selects and reads the still image capturing mode viewpoint region information stored in the storage medium 83 via the storage unit 82, incorporates the still image capturing mode viewpoint region information into the viewpoint association information, and supplies the viewpoint association information to the region specifying unit 56.

This still image capturing mode viewpoint region information indicates the viewpoint image region 131A having a size and a shape adopted in the still image capturing mode, as shown in A of FIG. 9, for example. That is, as the control unit 81 selects the still image capturing mode viewpoint region information, the viewpoint image regions corresponding to the still image capturing mode are set.

In step S103, under the control of the control unit 81, the image sensor 51 images the object in the still image capturing mode, and generates a captured image that is a still image.

In step S104, the region specifying unit 56 performs a region specifying process on the captured image generated in step S103, using the still image capturing mode viewpoint region information selected in step S102.

For example, in this region specifying process, the region specifying unit 56 supplies the association unit 70 with (the viewpoint association information including) the still image capturing mode viewpoint region information supplied in step S102, and associates the still image capturing mode viewpoint region information with the captured image (or the whole image) generated in step S103. Also, in this region specifying process, for example, the region specifying unit 56 supplies the region extraction unit 53 with (the viewpoint association information including) the still image capturing mode viewpoint region information supplied in step S102, and causes the region extraction unit 53 to cut out the viewpoint images from the captured image generated in step S103.

In step S105, each processing unit performs signal processing on the image or the like. For example, the RAW signal processing unit 52 performs predetermined signal processing on the captured image in the RAW format or the whole image. Also, the region extraction unit 53 extracts some regions (cuts out partial images) from the captured image in the RAW format, on the basis of the viewpoint association information supplied from the region specifying unit 56. For example, the region extraction unit 53 extracts the whole image or a plurality of viewpoint images from the captured image, and generates a composite image using the plurality of viewpoint images. The region extraction unit 53 then outputs the cutout image (the whole image, the viewpoint images, the composite image, or the like) (or supplies the cutout image to the RAW signal processing unit 52 and the camera signal processing unit 54). Note that the region extraction unit 53 can also output the captured image, without extracting any partial image.

Further, the camera signal processing unit 54 performs predetermined camera signal processing on the image (the captured image, the viewpoint images, the composite image, or the like) supplied from the region extraction unit 53. Also, the association unit 70 associates the supplied image (the captured image, the viewpoint images, or the composite image) with the viewpoint association information supplied from the region specifying unit 56. Note that the signal processing can be omitted (skipped).

In step S106, the image reconstruction processing unit 57 performs an image reconstruction process on the image (the captured image, the viewpoint images, or the composite image). The specifics of this image reconstruction process may be of any kind. For example, the image reconstruction process may be depth information generation, refocusing for generating (reconstructing) an image focused on any desired object, or the like. Note that this image reconstruction process can be omitted (skipped).

In step S107, the association unit 70 outputs the image (the captured image, the viewpoint images, or the composite image). For example, the storage unit 62 stores the image (the captured image, the viewpoint images, or the composite image) into the storage medium 63. Note that this image may be associated with the viewpoint association information through the process in step S105.

Also, the communication unit 64 transmits the image (the captured image, the viewpoint images, or the composite image) to another device, for example. For example, the communication unit 64 can transmit the data of the image and the like by a streaming method, a downloading method, or the like. Note that this image may be associated with the viewpoint association information through the process in step S105.

Further, the file generation unit 65 outputs the image (the captured image, the viewpoint images, or the composite image) turned into a file through the process in step S105, for example. For example, the file generation unit 65 may supply the file containing this image (the captured image, the viewpoint images, or the composite image) to the storage unit 62 and store the file into the storage medium 63, or may supply the file to the communication unit 64 to transmit the file to another device. Note that this image may be associated with the viewpoint association information through the process in step S105. That is, (the viewpoint association information including) the still image capturing mode viewpoint region information set in step S102 may be stored, together with the image (the captured image, the viewpoint images, or the composite image), in the file to be output from the file generation unit 65.

When the process in step S107 is completed, the imaging process comes to an end.

If the imaging mode is determined not to be the still image capturing mode (or is determined to be the moving image capturing mode) in step S101, on the other hand, the process moves on to step S111.

In step S111, the control unit 81 sets the viewpoint image regions corresponding to the moving image capturing mode, with the defective regions being taken into consideration. That is, as described above with reference to B of FIG. 9, the control unit 81 sets the viewpoint image regions so as to obtain images having the desired size and shape in the actual resolution regions. For example, the control unit 81 selects and reads the moving image capturing mode viewpoint region information stored in the storage medium 83 via the storage unit 82, and supplies the moving image capturing mode viewpoint region information to the region specifying unit 56.

This moving image capturing mode viewpoint region information indicates the viewpoint image regions 131B that are set so as to obtain images of the desired size and shape in the actual resolution regions as shown in B of FIG. 9, for example. That is, as the control unit 81 selects this moving image capturing mode viewpoint region information, the viewpoint image regions corresponding to the moving image capturing mode are set with the defective regions being taken into consideration.

In step S112, under the control of the control unit 81, the image sensor 51 images the object in the moving image capturing mode, and generates a captured image as one frame of a moving image.

In step S113, the region specifying unit 56 performs a region specifying process on the captured image generated in step S112, using the moving image capturing mode viewpoint region information selected in step S111. This process is performed in a manner similar to the process in step S104.

In step S114, each processing unit performs signal processing on the image or the like. This process is performed in a manner similar to the process in step S105.

In step S115, the image reconstruction processing unit 57 performs an image reconstruction process on the image (the captured image, the viewpoint images, or the composite image). This process is performed in a manner similar to the process in step S106.

In step S116, the association unit 70 outputs the image (the captured image, the viewpoint images, or the composite image). This process is performed in a manner similar to the process in step S107.

In step S117, the control unit 81 determines whether or not to end the imaging, on the basis of an instruction from the user or the like, for example. If it is determined not to end the imaging yet, the process returns to step S112, and the processes that follow are repeated. As the processes in steps S112 to S117 are performed, processing for one frame of the moving image is performed. The respective processes in steps S112 to S117 are then repeatedly performed until it is determined in step S117 to end the imaging, to generate the respective frames of the moving image.

If it is determined in step S117 to end the imaging, the imaging process comes to an end.

By performing the imaging process in such a manner, it is possible to obtain viewpoint images compatible with the imaging mode.

<In a Case where No Regions Outside the Effective Pixel Region are Included>

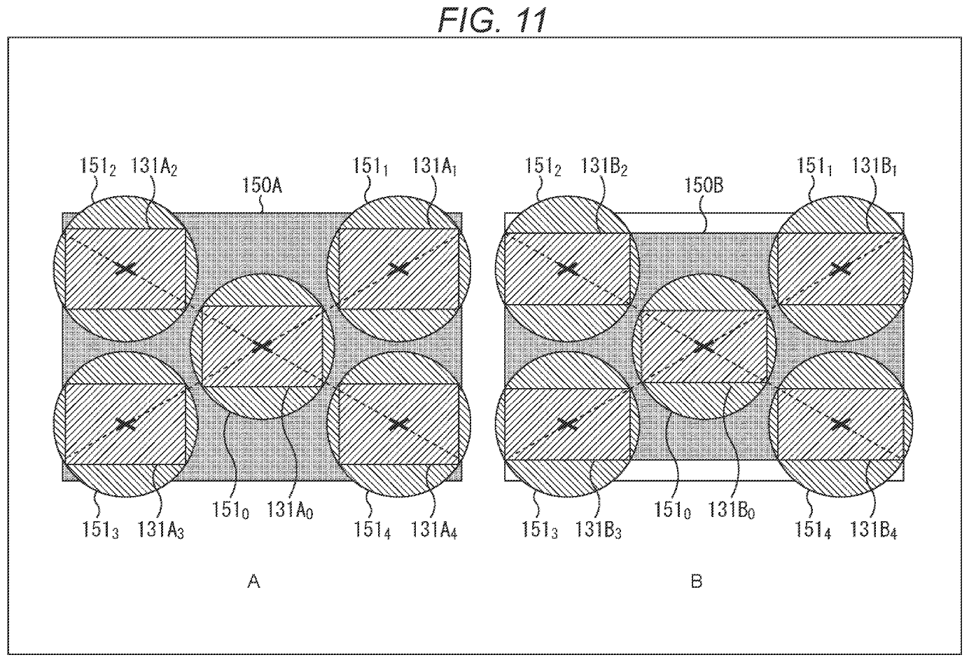

FIG. 11 shows an example of the viewpoint image regions in the respective imaging modes in a case where the viewpoint image regions include no regions outside the effective pixel region. The image sensor 51 is compatible with the still image capturing mode or the moving image capturing mode, as in the <Case Where Regions Outside the Effective Pixel Region Are Included>. Also, the effective pixel region of the image sensor 51 is set as in the example shown in FIG. 8 in each imaging mode.

The imaging mode may of course be any appropriate mode, and may be other than the still image capturing mode and the moving image capturing mode. Further, the effective pixel region may have any appropriate size and shape, and are not limited to the above example.

A of FIG. 11 is a diagram showing an example of the viewpoint image regions and the like in the still image capturing mode in this case. For example, when the control unit 81 selects the still image capturing mode viewpoint region information, the viewpoint image regions 131A shown in A of FIG. 11 are set.

As shown in A of FIG. 11, in this case, the respective monocular image regions 151 are also formed in the effective pixel region 150A as in the case shown in A of FIG. 9, and the respective viewpoint image regions 131A are also set as in the case shown in A of FIG. 9.

B of FIG. 11 is a diagram showing an example of the viewpoint image regions and the like in the moving image capturing mode. For example, when the control unit 81 selects the moving image capturing mode viewpoint region information, the viewpoint image regions shown in B of FIG. 11 are set.

Since the position of the optical axis of each monocular optical system 31 is fixed regardless of the imaging mode, light that has traveled from the object through the respective monocular optical systems 31 irradiates the same position on the light receiving surface of the image sensor 51, regardless of the imaging mode. Accordingly, as shown in B of FIG. 11, in the effective pixel region 150B, the monocular image regions 151₀ to 151₄ are formed at the same positions as those in the case shown in A of FIG. 11, and viewpoint image regions 131B (viewpoint image regions 131B₀ to 131B₄) having the size and the shape adopted in the moving image capturing mode are set in the respective monocular image regions. The positions of the respective viewpoint image regions 131B are designated at the same positions as those of the viewpoint image regions 131A.

In the example case shown in B of FIG. 11, all the viewpoint image regions 131B are set so as to be included in the effective pixel region 150B. Therefore, there are no defective regions in the viewpoint image regions in this case. In view of this, the size and the shape of the viewpoint image regions 131B are set so that images having the desired size and shape can be obtained in the viewpoint image regions. That is, the viewpoint image regions 131B having a size and a shape that can be adopted in the moving image capturing mode are set.

For example, the still image capturing mode viewpoint region information indicates the viewpoint image regions 131A having an aspect ratio of 3:2 and the desired resolution, and the moving image capturing mode viewpoint region information indicates the viewpoint image regions 131B having an aspect ratio of 16:9 and a lower resolution than that of the viewpoint image regions 131A.

By doing so, it is possible to obtain viewpoint images compatible with the imaging mode.

<Flow in an Imaging Process>

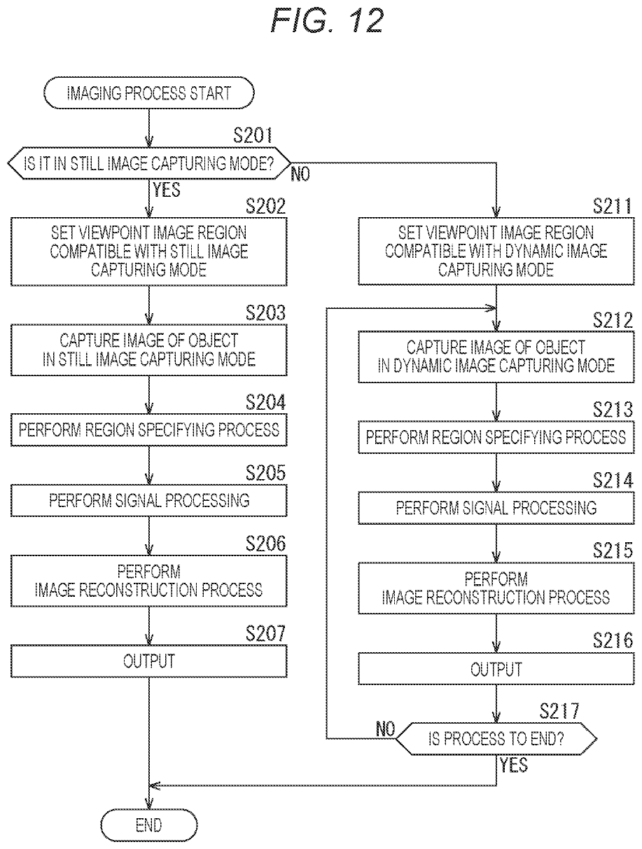

Referring now to a flowchart shown in FIG. 12, an example flow in the imaging process in this case is described.

In the imaging process in this case, the respective processes in steps S201 to S207 are performed in a manner similar to that in the respective processes in steps S101 to S107 in FIG. 10.

If the imaging mode is determined not to be the still image capturing mode (or is determined to be the moving image capturing mode) in step S201, on the other hand, the process moves on to step S211.

In step S211, the control unit 81 sets the viewpoint image regions corresponding to the moving image capturing mode. That is, as described above with reference to B of FIG. 11, the viewpoint image regions are set so that images of the desired size and shape can be obtained in the entire viewpoint image regions. For example, the control unit 81 selects and reads the moving image capturing mode viewpoint region information stored in the storage medium 83 via the storage unit 82, and supplies the moving image capturing mode viewpoint region information to the region specifying unit 56.

This moving image capturing mode viewpoint region information indicates the viewpoint image regions 131B that are set so as to obtain images of the desired size and shape in the entire viewpoint image regions as shown in B of FIG. 11, for example. That is, as the control unit 81 selects the moving image capturing mode viewpoint region information, the viewpoint image regions corresponding to the moving image capturing mode are set.

The respective processes in steps S212 to S217 are performed in a manner similar to that in the respective processes in steps S112 to S117 in FIG. 10. Further, if it is determined in step S217 to end the imaging, the imaging process comes to an end.

By performing the imaging process in such a manner, it is possible to obtain viewpoint images compatible with the imaging mode. Thus, more accurate depth estimation becomes possible in imaging using the multiple optical system 30. An application using the depth information calculated through the depth estimation can also be used in the field of video production, such as lens emulation, computer graphics (CG), and synthesis using the depths captured images.

### Other Example Configurations

Note that the control unit 81 may be an independent device. Also, the control unit 81, the storage unit 82, and the storage medium 83 may be independent devices. Further, these independent devices may include the RAW signal processing unit 52, the region extraction unit 53, the camera signal processing unit 54, the through-lens image generation unit 55, the region specifying unit 56, the image reconstruction processing unit 57, or the association unit 70, or two or more of these components. That is, the present technology can also be applied to an information processing device (or an image processing device) having no imaging functions.

### 2. Second Embodiment

<Camera System>

In the first embodiment, the present technology has been described through an example of the camera 10 including the multiple optical system 30. However, the present technology can also be applied to other configurations. For example, an optical system including the multiple optical system 30 may be replaceable. That is, the multiple optical system 30 may be designed to be detachable from the camera 10.

<Exterior of a Camera System>

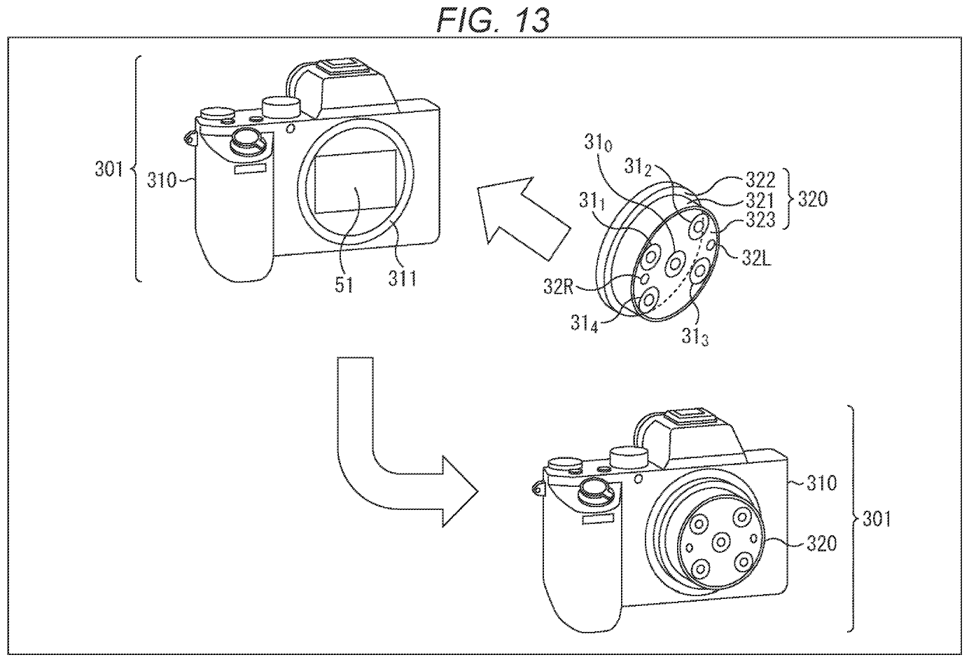

FIG. 13 is a perspective view showing an example configuration of an embodiment of a camera system to which the present technology is applied. A camera system 301 shown in FIG. 13 includes a camera body 310 and a multiple interchangeable lens 320 (the lens unit). In a state where the multiple interchangeable lens 320 is attached to the camera body 310, the camera system 301 has a configuration similar to that of the camera 10, and basically performs similar processes. That is, the camera system 301 functions as an imaging apparatus that captures an image of an object and generates image data of the captured image, like the camera 10.

The multiple interchangeable lens 320 is detachable from the camera body 310. Specifically, the camera body 310 includes a camera mount 311, and (the lens mount 322 of) the multiple interchangeable lens 320 is attached to the camera mount 311, so that the multiple interchangeable lens 320 is attached to the camera body 310. Note that a general interchangeable lens other than the multiple interchangeable lens 320 may be detachably attached to the camera body 310.

The camera body 310 includes an image sensor 51. The image sensor 51 receives light beams collected by the multiple interchangeable lens 320 or some other interchangeable lenses mounted on (the camera mount 311 of) the camera body 310, and performs photoelectric conversion to capture an image of the object.

The multiple interchangeable lens 320 includes a lens barrel 321 and the lens mount 322. The multiple interchangeable lens 320 also includes five monocular optical systems 31₀, 31₁, 31₂, 31₃, and 31₄ as a plurality of monocular optical systems.

The plurality of monocular optical systems 31 in this case is designed so that the optical paths of light passing through the respective systems are independent of one another, as in the case of the camera 10. That is, light having passed through each of the monocular optical systems 31 is emitted onto a different position on the light receiving surface (for example, the effective pixel region) of the image sensor 51, without entering the other monocular optical systems 31. At least the optical axes of the respective monocular optical systems 31 are located at different positions on the light receiving surface of the image sensor 51, and at least part of the light passing through the respective monocular optical systems 31 is emitted onto different positions on the light receiving surface of the image sensor 51.

Accordingly, in the captured image generated by the image sensor 51 (the entire image output by the image sensor 51), the images of the object formed through the respective monocular optical systems 31 are formed at different positions, as in the case of the camera 10. In other words, from the captured image, captured images (also referred to as viewpoint images) with the respective monocular optical systems 31 being the viewpoints are obtained. That is, as the multiple interchangeable lens 320 is attached to the camera body 310 to capture an image of the object, a plurality of viewpoint images can be obtained.

The lens barrel 321 has a substantially cylindrical shape, and the lens mount 322 is formed on one bottom surface side of the cylindrical shape. The lens mount 322 is attached to the camera mount 311 of the camera body 310 when the multiple interchangeable lens 320 is attached to the camera body 310.

The five monocular optical systems 31 are provided in the multiple interchangeable lens 320 and are arranged so that, with the monocular optical system 31₀ being the center (gravity center), the other four monocular optical systems 31₁ to 31₄ form the vertices of a rectangle in a two-dimensional plane that is orthogonal to the optical axis of the lens barrel (or is parallel to the light receiving surface (imaging surface) of the image sensor 51). The arrangement shown in FIG. 21 is of course an example, and the respective monocular optical systems 31 can be in any positional relationship, as long as the optical paths are independent of one another.

### Example Electrical Configuration of the Camera System

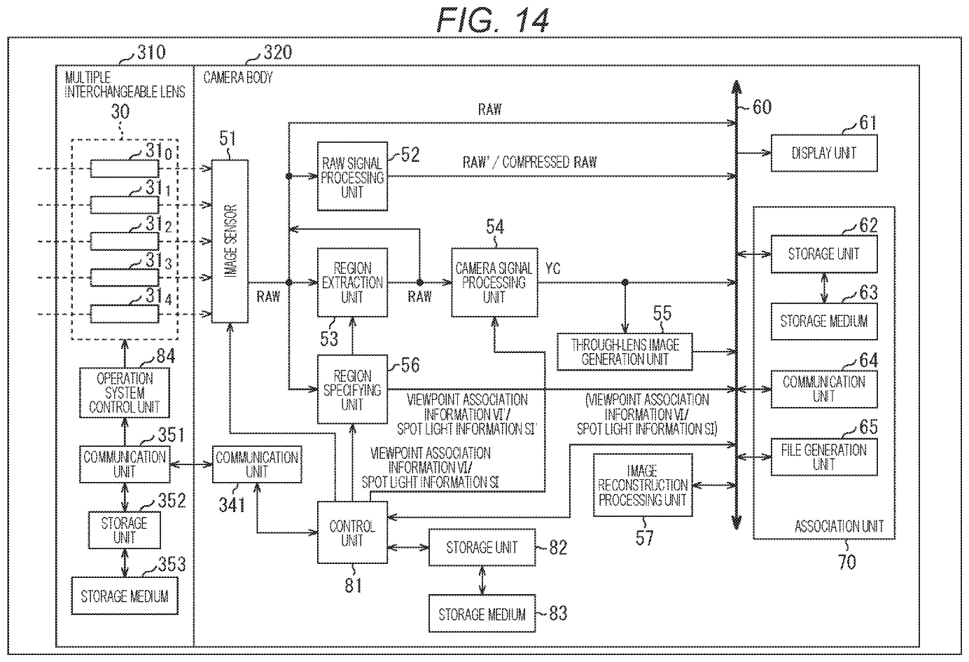

FIG. 14 is a block diagram showing an example electrical configuration of the camera system 301 shown in FIG. 21.

<Camera Body>

In the camera system 301, the camera body 310 includes the image sensor 51, a RAW signal processing unit 52, a region extraction unit 53, a camera signal processing unit 54, a through-lens image generation unit 55, a region specifying unit 56, an image reconstruction processing unit 57, a bus 60, a display unit 61, a storage unit 62, a communication unit 64, a file generation unit 65, a control unit 81, and a storage unit 82. That is, the camera body 310 has the components provided in the lens barrel 20 of the camera 10, except for the multiple optical system 30 and the optical system control unit 84.

Note that the camera body 310 includes a communication unit 341, in addition to the above-described components. This communication unit 341 is a processing unit that communicates with (a communication unit 351 of) the multiple interchangeable lens 320 properly attached to the camera body 310, to exchanges information and the like. The communication unit 341 can communicate with the multiple interchangeable lens 320 by any appropriate communication method. The communication may be cable communication or wireless communication.

For example, the communication unit 341 is controlled by the control unit 81, performs the communication, and acquires information supplied from the multiple interchangeable lens 320. Through the communication, the communication unit 341 also supplies the multiple interchangeable lens 320 with information supplied from the control unit 81, for example. The information to be exchanged with the multiple interchangeable lens 320 may be any appropriate information. For example, the information may be data, or may be control information such as a command or control parameters.

<Multiple Interchangeable Lens>

In the camera system 301, the multiple interchangeable lens 320 includes the communication unit 351 and a storage unit 352, in addition to a multiple optical system 30 and an optical system control unit 84. In the multiple interchangeable lens 320 properly attached to the camera body 310, the communication unit 351 communicates with the communication unit 341. Through this communication, information exchange between the camera body 310 and the multiple interchangeable lens 320 is performed. The communication method to be implemented by the communication unit 351 may be cable communication or wireless communication. Further, the information to be exchanged through this communication may be data, or may be control information such as a command or control parameters.

For example, the communication unit 351 acquires control information that is transmitted from the camera body 310 via the communication unit 341. The communication unit 351 supplies the information acquired in this manner to the optical system control unit 84 as necessary, so that the information can be used in controlling the multiple optical system 30.

Also, the communication unit 351 can supply the acquired information to the storage unit 352, and store the information into a storage medium 353. Further, the communication unit 351 can read information stored in the storage medium 353 via the storage unit 352, and transmit the read information to the camera body 310 (the communication unit 341).

Note that the storage medium 353 may be a ROM, or may be a rewritable memory such as a RAM or a flash memory. In the case of a rewritable memory, the storage medium 353 can store desired information.

Even in the case of such a configuration, the control unit 81 sets the viewpoint image regions in accordance with the imaging mode, as in the case of the camera 10 described in the first embodiment. By doing so, it is possible to obtain viewpoint images compatible with the imaging mode. That is, by applying the present technology to the camera system 301, it is possible to achieve various effects similar to those in the case of the camera 10 described in the first embodiment.

Note that the viewpoint region information can be stored in any appropriate storage medium. For example, in the case of the camera system 301 in FIG. 14, the viewpoint region information may be stored in the storage medium 353 of the multiple interchangeable lens 320.

### 3. Notes

<Computer>

The series of processes described above can be performed by hardware or can be performed by software. When the series of processes are to be performed by software, the program that forms the software is installed into a computer. Here, the computer may be a computer incorporated into special-purpose hardware, or may be a general-purpose personal computer or the like that can execute various kinds of functions when various kinds of programs are installed thereinto, for example.

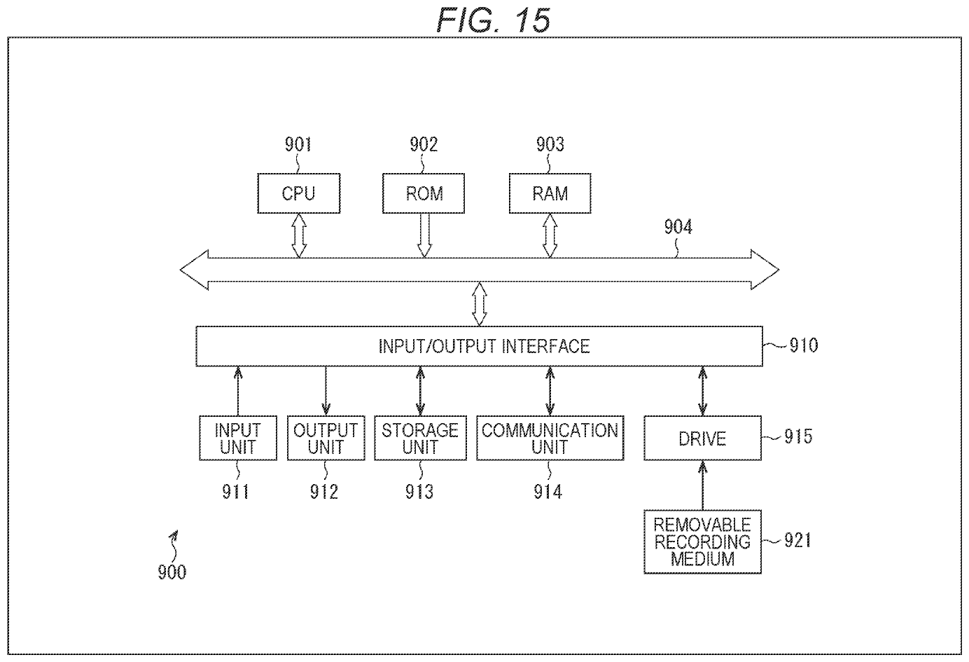

FIG. 15 is a block diagram showing an example configuration of the hardware of a computer that performs the above described series of processes in accordance with a program.

In a computer 900 shown in FIG. 15, a central processing unit (CPU) 901, a read only memory (ROM) 902, and a random access memory (RAM) 903 are connected to one another by a bus 904.

An input/output interface 910 is also connected to the bus 904. An input unit 911, an output unit 912, a storage unit 913, a communication unit 914, and a drive 915 are connected to the input/output interface 910.

The input unit 911 is formed with a keyboard, a mouse, a microphone, a touch panel, an input terminal, and the like, for example. The output unit 912 is formed with a display, a speaker, an output terminal, and the like, for example. The storage unit 913 is formed with a hard disk, a RAM disk, a nonvolatile memory, and the like, for example. The communication unit 914 is formed with a network interface, for example. The drive 915 drives a removable recording medium 921 such as a magnetic disk, an optical disk, a magnetooptical disk, or a semiconductor memory.

In the computer having the above described configuration, the CPU 901 loads a program stored in the storage unit 913 into the RAM 903 via the input/output interface 910 and the bus 904, for example, and executes the program, so that the above described series of processes is performed. The RAM 903 also stores data necessary for the CPU 901 to perform various processes and the like as necessary.

The program to be executed by the computer can be recorded on the removable recording medium 921 as a packaged medium or the like to be used, for example. In that case, the program can be installed into the storage unit 913 via the input/output interface 910 when the removable recording medium 921 is mounted on the drive 915.

Alternatively, this program can be provided via a wired or wireless transmission medium such as a local area network, the Internet, or digital satellite broadcasting. In that case, the program can be received by the communication unit 914, and be installed into the storage unit 913.

Also, this program can be installed beforehand into the ROM 902 or the storage unit 913.

<Targets to which the Present Technology is Applied>

The present technology can be applied to any appropriate configuration. For example, the present technology can also be embodied as a component of an apparatus, such as a processor serving as a system large scale integration (LSI) or the like, a module using a plurality of processors or the like, a unit using a plurality of modules or the like, or a set having other functions added to the unit.

Further, for example, the present technology can also be applied to a network system formed with a plurality of devices. For example, the present technology may be embodied as cloud computing that is shared and jointly processed by a plurality of devices via a network. For example, the present technology may be embodied in a cloud service that provides services to any kinds of terminals such as computers, portable information processing terminals, and IoT (Internet of Things) devices.

Note that, in the present specification, a system means an assembly of a plurality of components (devices, modules (parts), and the like), and not all the components need to be provided in the same housing. In view of this, a plurality of devices that are housed in different housings and are connected to one another via a network form a system, and one device having a plurality of modules housed in one housing is also a system.

<Fields and Usage to which the Present Technology can be Applied>

A system, an apparatus, a processing unit, and the like to which the present technology is applied can be used in any appropriate field such as transportation, medical care, crime prevention, agriculture, the livestock industry, mining, beauty care, factories, home electric appliances, meteorology, or nature observation, for example. The present technology can also be used for any appropriate purpose.

### Other Aspects

Embodiments of the present technology are not limited to the embodiments described above, and various modifications may be made to them without departing from the scope of the present technology.

For example, any configuration described above as one device (or one processing unit) may be divided into a plurality of devices (or processing units). Conversely, any configuration described above as a plurality of devices (or processing units) may be combined into one device (or one processing unit). Furthermore, it is of course possible to add a component other than those described above to the configuration of each device (or each processing unit). Further, some components of a device (or processing unit) may be incorporated into the configuration of another device (or processing unit) as long as the configuration and the functions of the entire system remain substantially the same.

Also, the program described above may be executed in any device, for example. In that case, the device is only required to have necessary functions (function blocks and the like) so that necessary information can be obtained.

Also, one device may carry out each step in one flowchart, or a plurality of devices may carry out each step, for example. Further, in a case where one step includes a plurality of processes, the plurality of processes may be performed by one device or may be performed by a plurality of devices. In other words, a plurality of processes included in one step can be performed as processes in a plurality of steps. Conversely, processes described as a plurality of steps can be collectively performed as one step.

Also, a program to be executed by a computer may be a program for performing the processes in the steps according to the program in chronological order in accordance with the sequence described in this specification, or may be a program for performing processes in parallel or performing a process when necessary, such as when there is a call, for example. That is, as long as there are no contradictions, the processes in the respective steps may be performed in a different order from the above described order. Further, the processes in the steps according to this program may be executed in parallel with the processes according to another program, or may be executed in combination with the processes according to another program.

Also, each of the plurality of techniques according to the present technology can be independently implemented, as long as there are no contradictions, for example. It is of course also possible to implement a combination of some of the plurality of techniques according to the present technology. For example, part or all of the present technology described in one of the embodiments can be implemented in combination with part or all of the present technology described in another one of the embodiments. Further, part or all of the present technology described above can be implemented in combination with some other technology not described above.

Note that the present technology can also be embodied in the configurations described below.

(1) An information processing device including

a setting unit that sets viewpoint image regions in accordance with an imaging mode of a captured image, the captured image being generated by an image sensor that has different positions irradiated with irradiation light beams having passed through a plurality of monocular optical systems that have optical paths independent of one another, the viewpoint image regions being regions of viewpoint images corresponding to the respective monocular optical systems.

(2) The information processing device according to (1), in which

the setting unit sets the viewpoint image regions on the basis of an aspect ratio that is set in accordance with the imaging mode.

(3) The information processing device according to (1) or (2), in which

the setting unit sets the viewpoint image regions on the basis of a resolution that is set in accordance with the imaging mode.

(4) The information processing device according to any one of (1) to (3), in which,

when viewpoint image candidate regions that are candidates for the viewpoint images include defective regions outside an effective pixel region, the setting unit sets the viewpoint image regions so as to obtain images of a desired size and a desired aspect ratio in actual resolution regions that are not the defective regions in the viewpoint image candidate regions.

(5) The information processing device according to any one of (1) to (4), in which

the setting unit sets the viewpoint image regions by designating coordinates of a predetermined position in the viewpoint images.

(6) The information processing device according to (5), in which

the setting unit sets the viewpoint image regions by further designating a size and a shape of the viewpoint images.

(7) The information processing device according to any one of (1) to (6), in which

the setting unit sets the viewpoint image regions by selecting viewpoint region information in accordance with the imaging mode, the viewpoint region information being information indicating the viewpoint image regions.

(8) The information processing device according to (7), further including

a storage unit that stores the viewpoint region information related to each imaging mode,

in which the setting unit selects the viewpoint region information corresponding to the imaging mode from the viewpoint region information related to each imaging mode stored in the storage unit.

(9) The information processing device according to any one of (1) to (8), further including

an association unit that associates the captured image or an image generated using the captured image, with viewpoint region information that is information indicating the viewpoint image regions set by the setting unit.

(10) The information processing device according to any one of (1) to (9), further including

a cutout unit that cut outs, from the captured image, images in the viewpoint image regions set by the setting unit.

(11) An information processing method including

setting viewpoint image regions in accordance with an imaging mode of a captured image, the captured image being generated by an image sensor that has different positions irradiated with irradiation light beams having passed through a plurality of monocular optical systems that have optical paths independent of one another, the viewpoint image regions being regions of viewpoint images corresponding to the respective monocular optical systems.

(12) A program for causing a computer to function as

a setting unit that sets viewpoint image regions in accordance with an imaging mode of a captured image, the captured image being generated by an image sensor that has different positions irradiated with irradiation light beams having passed through a plurality of monocular optical systems that have optical paths independent of one another, the viewpoint image regions being regions of viewpoint images corresponding to the respective monocular optical systems.

(13) An imaging apparatus including:

an imaging unit that generates a captured image by photoelectrically converting, in a predetermined imaging mode, irradiation light beams having passed through a plurality of monocular optical systems that have optical paths independent of one another; and

a setting unit that sets, in accordance with the imaging mode, viewpoint image regions for the captured image generated by the imaging unit, the viewpoint image regions being regions of viewpoint images corresponding to the respective monocular optical systems.

(14) The imaging apparatus according to (13), in which

the setting unit sets the viewpoint image regions by selecting viewpoint region information in accordance with the imaging mode, the viewpoint region information being information indicating the viewpoint image regions.

(15) The imaging apparatus according to (14), further including

a communication unit that communicates with a multiple interchangeable optical system, the multiple interchangeable optical system including the plurality of monocular optical systems and a storage unit storing the viewpoint region information related to each imaging mode,

in which the setting unit acquires the viewpoint region information related to each imaging mode stored in the storage unit of the multiple interchangeable optical system via the communication unit, and selects the viewpoint region information corresponding to the imaging mode from the acquired viewpoint region information.

(16) The imaging apparatus according to (14), further including

a storage unit that stores the viewpoint region information related to each imaging mode,

in which the setting unit selects the viewpoint region information corresponding to the imaging mode from the viewpoint region information related to each imaging mode stored in the storage unit.

(17) The imaging apparatus according to any one of (13) to (16), further including

the plurality of the monocular optical systems.

(18) An imaging method including:

generating a captured image by photoelectrically converting, in a predetermined imaging mode, irradiation light beams having passed through a plurality of monocular optical systems that have optical paths independent of one another; and

setting, in accordance with the imaging mode, viewpoint image regions for the generated captured image, the viewpoint image regions being regions of viewpoint images corresponding to the respective monocular optical systems.

(19) A program for causing a computer to function as:

an imaging unit that generates a captured image by photoelectrically converting, in a predetermined imaging mode, irradiation light beams having passed through a plurality of monocular optical systems that have optical paths independent of one another; and

a setting unit that sets, in accordance with the imaging mode, viewpoint image regions for the captured image generated by the imaging unit, the viewpoint image regions being regions of viewpoint images corresponding to the respective monocular optical systems.

(20) An interchangeable lens including:

a plurality of monocular optical systems having optical paths independent of one another; and

a storage unit that stores viewpoint region information, the viewpoint region information being information related to each imaging mode and indicating viewpoint image regions, the viewpoint image regions being regions of viewpoint images corresponding to the respective monocular optical systems.

### REFERENCE SIGNS LIST

10 Camera
30 Multiple optical system
31 Monocular optical system
51 Image sensor
52 RAW signal processing unit
53 Region extraction unit
54 Camera signal processing unit
55 Through-lens image generation unit
56 Region specifying unit
57 Image reconstruction processing unit
60 Bus
61 Display unit
62 Storage unit
63 Storage medium
64 Communication unit
65 File generation unit
70 Association unit
81 Control unit
82 Storage unit
83 Storage medium
84 Optical system control unit
301 Camera system
310 Camera body
320 Multiple interchangeable lens
341 Communication unit
351 Communication unit
352 Storage unit
353 Storage medium

1. An information processing device comprising
a setting unit that sets viewpoint image regions in accordance with an imaging mode of a captured image, the captured image being generated by an image sensor that has different positions irradiated with irradiation light beams having passed through a plurality of monocular optical systems that have optical paths independent of one another, the viewpoint image regions being regions of viewpoint images corresponding to the respective monocular optical systems.

2. The information processing device according to claim 1, wherein
the setting unit sets the viewpoint image regions on a basis of an aspect ratio that is set in accordance with the imaging mode.

3. The information processing device according to claim 1, wherein
the setting unit sets the viewpoint image regions on a basis of a resolution that is set in accordance with the imaging mode.

4. The information processing device according to claim 1, wherein,
when viewpoint image candidate regions that are candidates for the viewpoint images include defective regions outside an effective pixel region, the setting unit sets the viewpoint image regions so as to obtain images of a desired size and a desired aspect ratio in actual resolution regions that are not the defective regions in the viewpoint image candidate regions.

5. The information processing device according to claim 1, wherein
the setting unit sets the viewpoint image regions by designating coordinates of a predetermined position in the viewpoint images.

6. The information processing device according to claim 5, wherein
the setting unit sets the viewpoint image regions by further designating a size and a shape of the viewpoint images.

7. The information processing device according to claim 1, wherein
the setting unit sets the viewpoint image regions by selecting viewpoint region information in accordance with the imaging mode, the viewpoint region information being information indicating the viewpoint image regions.

8. The information processing device according to claim 7, further comprising
a storage unit that stores the viewpoint region information related to each imaging mode,
wherein the setting unit selects the viewpoint region information corresponding to the imaging mode from the viewpoint region information related to each imaging mode stored in the storage unit.

9. The information processing device according to claim 1, further comprising
an association unit that associates the capture image or an image generated using the captured image, with viewpoint region information that is information indicating the viewpoint image regions set by the setting unit.

10. The information processing device according to claim 1, further comprising
a cutout unit that cut outs, from the captured image, images in the viewpoint image regions set by the setting unit.

11. An information processing method comprising
setting viewpoint image regions in accordance with an imaging mode of a captured image, the captured image being generated by an image sensor that has different positions irradiated with irradiation light beams having passed through a plurality of monocular optical systems that have optical paths independent of one another, the viewpoint image regions being regions of viewpoint images corresponding to the respective monocular optical systems.

12. A program for causing a computer to function as
a setting unit that sets viewpoint image regions in accordance with an imaging mode of a captured image, the captured image being generated by an image sensor that has different positions irradiated with irradiation light beams having passed through a plurality of monocular optical systems that have optical paths independent of one another, the viewpoint image regions being regions of viewpoint images corresponding to the respective monocular optical systems.

13. An imaging apparatus comprising:
an imaging unit that generates a captured image by photoelectrically converting, in a predetermined imaging mode, irradiation light beams having passed through a plurality of monocular optical systems that have optical paths independent of one another; and
a setting unit that sets, in accordance with the imaging mode, viewpoint image regions for the captured image generated by the imaging unit, the viewpoint image regions being regions of viewpoint images corresponding to the respective monocular optical systems.

14. The imaging apparatus according to claim 13, wherein
the setting unit sets the viewpoint image regions by selecting viewpoint region information in accordance with the imaging mode, the viewpoint region information being information indicating the viewpoint image regions.

15. The imaging apparatus according to claim 14, further comprising
a communication unit that communicates with a multiple interchangeable optical system, the multiple interchangeable optical system including the plurality of monocular optical systems and a storage unit storing the viewpoint region information related to each imaging mode,
wherein the setting unit acquires the viewpoint region information related to each imaging mode stored in the storage unit of the multiple interchangeable optical system via the communication unit, and selects the viewpoint region information corresponding to the imaging mode from the acquired viewpoint region information.

16. The imaging apparatus according to claim 14, further comprising
a storage unit that stores the viewpoint region information related to each imaging mode,
wherein the setting unit selects the viewpoint region information corresponding to the imaging mode from the viewpoint region information related to each imaging mode stored in the storage unit.

17. The imaging apparatus according to claim 13, further comprising
the plurality of the monocular optical systems.

18. An imaging method comprising:
generating a captured image by photoelectrically converting, in a predetermined imaging mode, irradiation light beams having passed through a plurality of monocular optical systems that have optical paths independent of one another; and
setting, in accordance with the imaging mode, viewpoint image regions for the generated captured image, the viewpoint image regions being regions of viewpoint images corresponding to the respective monocular optical systems.

19. A program for causing a computer to function as:
an imaging unit that generates a captured image by photoelectrically converting, in a predetermined imaging mode, irradiation light beams having passed through a plurality of monocular optical systems that have optical paths independent of one another; and
a setting unit that sets, in accordance with the imaging mode, viewpoint image regions for the captured image generated by the imaging unit, the viewpoint image regions being regions of viewpoint images corresponding to the respective monocular optical systems.

20. An interchangeable lens comprising:
a plurality of monocular optical systems having optical paths independent of one another; and
a storage unit that stores viewpoint region information, the viewpoint region information being information related to each imaging mode and indicating viewpoint image regions, the viewpoint image regions being regions of viewpoint images corresponding to the respective monocular optical systems.
